(19) United States
(12) Patent Application Publication
(10) Pub. No.: US 2012/0290592 A1
(43) Pub. Date: Nov. 15, 2012

(54) FEDERATED SEARCH APPARATUS, FEDERATED SEARCH SYSTEM, AND FEDERATED SEARCH METHOD

(75) Inventor: YOHSUKE ISHII, Yokohama (JP)

(73) Assignee: Hitachi Solutions, Ltd.

(21) Appl. No.: 13/403,555

(22) Filed: Feb. 23, 2012

(30) Foreign Application Priority Data
May 10, 2011 (JP) 2011-104870

(51) Int. Cl. G06F 17/30

(52) U.S. Cl. 707/754; 707/E17.059

(57) ABSTRACT

Provided is a technique that can control a federated search apparatus to prevent transmission of access account information, which is not necessary to carry out security trimming, to search servers in the execution of federated search. The federated search apparatus according to the present invention includes an account correspondence table describing a correspondence between a first access account that issues a first search request for requesting federated search and second access accounts that issue a second search request to the search apparatuses. The federated search apparatus specifies the second access account corresponding to the first access account in accordance with the description of the account correspondence table, designates, as a search condition, a range that can be accessed by the second access account, and issues the second search request to the search servers.

### CLAIM OF PRIORITY

The present application claims priority from Japanese patent application JP 2011-104870 filed on May 10, 2011, the content of which is hereby incorporated by reference into this application.

### BACKGROUND OF THE INVENTION

1. Field of the Invention

The present invention relates to a technique of providing federated search.

2. Background Art

Computers are widely used in various types of business and applications as a result of increased performance and reduced price of the computers. In recent years, the number of data files stored in a computer system has been increased, which causes a problem that the user cannot recall where the desired file is stored. A full-text search service is started to be used to handle the problem.

In the full-text search service, a search server analyzes file data stored in the computer system to create a search index in advance. The user transmits, to the search server, a search query for searching for the file to be acquired and accesses the target file based on the search result.

The amount of file data stored in computer systems is considered to further increase in the future, and users will have more trouble thoroughly figuring out where and which file data is stored. It is, therefore, considered that the search service may be more important for the users, and the uses of the service will further increase.

Many of the search servers apply security trimming to the search result. The security trimming is a function of filtering the content included in the search result to content for which the user who has issued the search request has an access right to provide a search result. For example, when an ACL (Access Control List) is set to the search target file as access control information, the search server determines whether the user has an access right to the target file based on the ACL information. Based on the result, the search server determines whether to include information related to the file in the search result. The function can prevent an unauthorized access to the file by the user through the search result.

Meanwhile, when there are a plurality of search servers, the user needs to separately issue a search request to each search server to separately acquire the result. The user needs to issue the same search query to the plurality of search servers for the number of times of the search servers, and this is not convenient for the user. To solve this, a federated search service is started to be used, in which the search results can be integrally acquired from all search servers just by issuing the search query once to a plurality of independent search servers. For example, a specification for federated search called OpenSearch is disclosed to the public and used.

In the federated search service, the search servers independently operate, and each search server can receive a search request through a unified standard interface such as OpenSearch. This can realize the federated search with loosely coupled search servers. In the loosely coupled federated search, the search algorithm, the search index update timing, and the like used by the search servers are different. Meanwhile, there is a mode of integrally operating a plurality of search servers to provide a tightly coupled federated search service. In the tightly coupled federated search service, the search servers use the same search algorithm, and the search index is integrally updated in the system.

In the operation of the computer system, there can be an environment in which a plurality of network domains coexist for authentication, and the search servers separately operate in the network domains. For example, there is a case in which the network domain is set for each of a plurality of sections in an enterprise, and the network domains are separately operated. In such an environment, a system utilization method is implemented in which a plurality of network domains provide access accounts to a user if necessary, and the user selects and uses the access accounts.

In the tightly coupled federated search service, the network domain for authentication is common to the search servers in many cases. Meanwhile, the network domain for authentication may be separately set in each search server in the loosely coupled federated search service. Therefore, the access accounts for accessing the search servers may be dispersed to the search servers.

Ideally, it is desirable to realize single sign-on in which the access accounts are consolidated into one network domain, and all services can be used if there is one of the access accounts. However, due to restrictions in operation and the like, there are still many environments with a plurality of network domains. When the federated search service is provided in the environment with network domains, the convenience of the user is significantly impaired by the selective use of the access accounts and the separate authentication in order to access the search servers in different network domains and to access data as search results. Therefore, there is a method of virtually realizing a service equivalent to single sign-on by associating a plurality of access accounts with one user and acquiring necessary information from the association information to internally execute a necessary authentication process.

U.S. Patent Publication No. 2010/0106712 A1 discloses a technique related to the virtual single sign-on. In the method, when a search server that provides federated search searches file servers that use different network domains, access accounts in the network domains and the user are associated, and the association information is registered in the search server. As a result, when a federated search request is issued to the search server, the user who has requested the search can acquire a security-trimmed federated search result based on the associated access accounts without being conscious of the difference between the network domains.

### SUMMARY OF THE INVENTION

In the technique described in U.S. Patent Publication No. 2010/0106712 A1, when a search request is transmitted to the search servers to carry out the federated search, information related to all access accounts associated with the user who requests the search is transmitted to the search servers. Fundamentally, when there are a plurality of authentication servers for carrying out the federated search, the access account information that needs to be referenced by the search servers is only information related to the authentication servers or the network domains used by the search servers, and other access account information is not necessary. If unnecessary access account information is transmitted to the search servers, there may be a security concern.

The problem becomes prominent when a federated search service collaborated with search servers on the Internet is provided. In this case, information related to authentication servers and access accounts in an intranet may be transmitted to the Internet, and the information may be leaked. This is not desirable in terms of security.

The present invention has been made to solve the problem, and an object of the present invention is to provide a technique that can control a federated search apparatus to prevent transmission of access account information, which is not necessary to carry out security trimming, to search servers in the execution of federated search.

A federated search apparatus according to the present invention includes an account correspondence table describing a correspondence between a first access account that issues a first search request for requesting federated search and second access accounts that issue a second search request to the search apparatuses. The federated search apparatus specifies the second access account corresponding to the first access account in accordance with the description of the account correspondence table, designates, as a search condition, a range that can be accessed by the second access account, and issues the second search request to the search servers.

According to the federated search apparatus of the present invention, transmission of access account information that is not necessary for search apparatuses to carry out security trimming can be prevented. As a result, leak of information related to the access accounts can be prevented.

### BRIEF DESCRIPTION OF THE DRAWINGS

FIG. 1 is a diagram showing a system configuration of a federated search system 10000 according to a first embodiment.

FIG. 2 is a diagram showing a hardware configuration of a federated search server 1100.

FIG. 3 is a diagram showing a hardware configuration of a search server 2200.

FIG. 4 is a diagram showing a hardware configuration of an authentication server 3100.

FIG. 5 is a diagram showing a hardware configuration of a file server 4200.

FIG. 6 is a diagram showing a hardware configuration of a client machine 5100.

FIG. 7 is a diagram showing flows of various processes when a user issues a federated search request from the client machine 5100 to the federated search server 1100.

FIG. 8 is a diagram showing a data structure of a federated search request packet 7000.

FIG. 9 is a diagram showing a data structure of a search request packet 8000.

FIG. 10 is a diagram showing a configuration and an example of data of an account correspondence management table 6100.

FIG. 11 is a diagram showing a configuration and an example of data of a search server management table 6200.

FIG. 12 is a diagram showing a configuration and an example of data of a search index management table 6300 included in the search server 2200.

FIG. 13 is a diagram showing a configuration and an example of data of a search index registration file management table 6400 included in the search server 2200.

FIG. 14 shows a flow of a process of requesting registration of an access account from the client machine 5100 to the federated search server 1100 or the search server 2200.

FIG. 15 is a diagram showing a flow of a log-on process in processing step S101 of FIG. 14.

FIG. 16 is a diagram showing a flow of an access account registration process in steps S104 and S105 of FIG. 14.

FIG. 17 shows a flow of a process of requesting registration, in the search server 2200, of a shared folder as a search target from the client machine 5100 to the search server 2200.

FIG. 18 is a diagram showing a flow of a process in step S402 of FIG. 17.

FIG. 19 is a diagram showing a flow of a process of requesting federated search from the client machine 5100 to the federated search server 1100.

FIG. 20 is a diagram showing a flow of a federated search process in step S602 of FIG. 19.

FIG. 21 is a diagram showing a flow of a search process in step S707 of FIG. 20.

FIG. 22 is a diagram showing a flow of step S602 of FIG. 19 according to a second embodiment.

FIG. 23 is a diagram showing a flow of the access account registration process of steps S104 and S105 according to a third embodiment.

FIG. 24 is a diagram showing a flow of the federated search process of step S602 according to the third embodiment.

FIG. 25 is a diagram showing a configuration and an example of data of the search server management table 6200 according to a fourth embodiment.

FIG. 26 is a diagram showing a flow of the process of step S402 according to the fourth embodiment.

FIG. 27 is a diagram showing a flow of the federated search process of step S602 according to the fourth embodiment.

FIG. 28 is a diagram showing a flow of the federated search process of step S602 according to a fifth embodiment.

FIG. 29 is a diagram showing a flow of the search process of step S707 according to the fifth embodiment.

FIG. 30 is a diagram showing a hardware configuration of the search server 2200 according to a sixth embodiment.

FIG. 31 is a diagram showing a flow of the entire federated search process according to a seventh embodiment.

FIG. 32 is a diagram showing a data structure of the search request packet 8000 according to the seventh embodiment.

FIG. 33 is a diagram showing a flow of the federated search process of step S602 according to the seventh embodiment.

FIG. 34 is a diagram showing a flow of the search process of step S707 according to the seventh embodiment.

### DETAILED DESCRIPTION OF THE PREFERRED EMBODIMENTS

### First Embodiment

A first embodiment of the present invention describes a method in which in response to a search request from a user, search servers that carry out federated search are filtered down based on access account information associated with the user, and when the search request is issued to the search servers, access account information for security trimming is filtered down to information that can be used by the search servers.

In the present embodiment, the access account information used to apply security trimming to the search result may be any form of information as long as the information can specify the user. An example of the information includes a user identification number, a user name, and a digital certificate storing data that can specify the user.

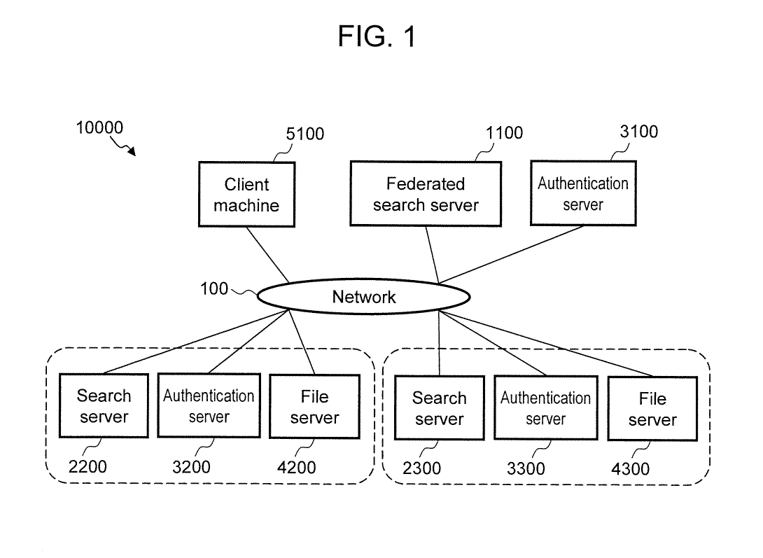

FIG. 1 is a diagram showing a system configuration of a federated search system 10000 according to the first embodiment. In the federated search system 10000, a federated search server 1100, search servers 2200 and 2300, authentication servers 3100, 3200, and 3300, file servers 4200 and 4300, and a client machine 5100 are connected through a network 100. The search server 2200, the authentication server 3200, and the file server 4200 belong to a same network domain. The search server 2300, the authentication server 3300, and the file server 4300 belong to another same network domain.

The federated search server 1100 provides a federated search service of issuing a search request to one or more search servers and integrating acquired search results to provide the search results to a search request source. The search server 2200 provides a file search service of electronic data (hereinafter, “files”) stored in the file server 4200. The authentication server 3100 manages authentication information necessary to execute an authentication process for the servers and executes the actual authentication process. In accordance with an instruction from the user, the client machine 5100 issues a search request to the search server 2200, issues a federated search request to the federated search server 1100, and issues a file access request to the file server 4200. The user can use the federated search system 10000 to carry out federated search for integrating the search results of the search servers to acquire a federated search result.

Upon the search, the search server 2200 uses a search index created in advance to generate a search result and filters (security trimming) the search results so that the search results include only information related to files for which the user has a right to refer to. This prevents access to files for which the user does not have a right to refer to.

Although the number of each server and the like is one in FIG. 1, the arrangement is not limited to this. The number of each server and the like may be two or more if possible. Although the servers and the like are different apparatuses in FIG. 1, the arrangement is not limited to this. Arbitrary two or more servers and the like may constitute one apparatus if possible. The network 100 may be any form of network. For example, an Internet connection may be provided, or an intranet connection based on a local area network may be provided.

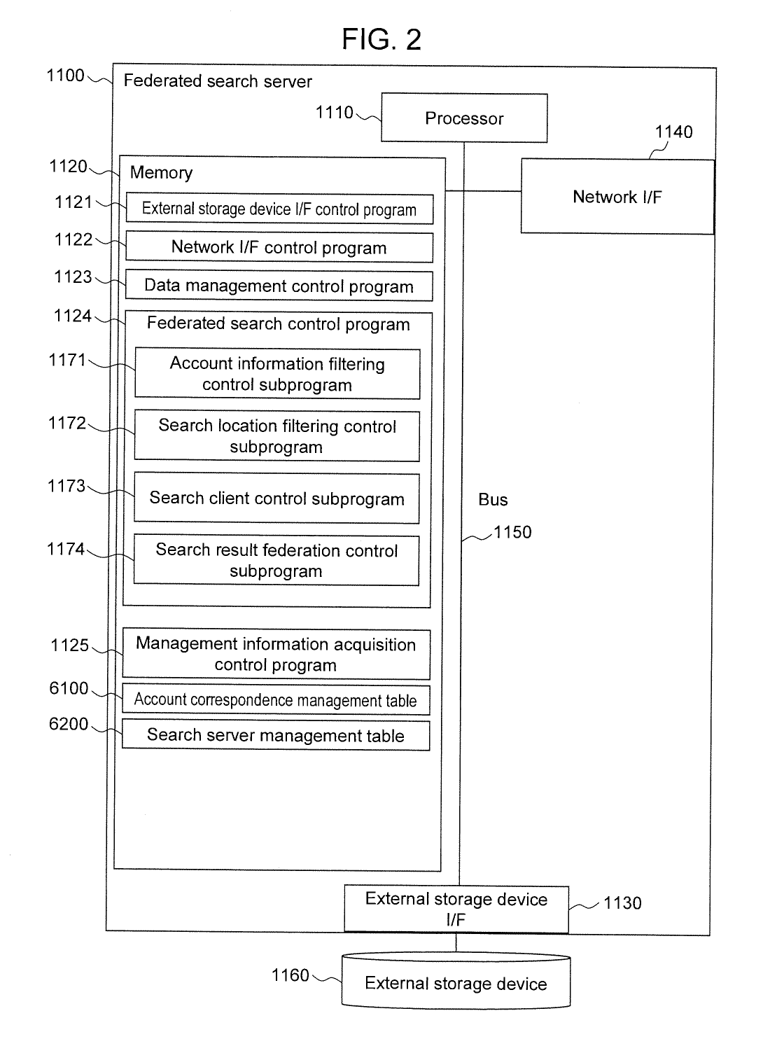

FIG. 2 is a diagram showing a hardware configuration of the federated search server 1100. The federated search server 1100 includes a processor 1110, a memory 1120, an external storage device I/F 1130, a network I/F 1140, a bus 1150, and an external storage device 1160.

The processor 1110 executes programs described below. Although the programs may be described as operating entities for the convenience of the description, it should be noted that arithmetic units, such as the processor 1110, actually execute the programs. The same applies to the other servers and the client machine 5100.

The memory 1120 temporarily stores the programs and data described below. The external storage device I/F 1130 is an interface for accessing the external storage device 1160. The network I/F 1140 is an interface for accessing other apparatuses connected through the network 100. The bus 1150 connects the constituent elements.

The memory 1120 stores an external storage device I/F control program 1121, a network I/F control program 1122, a data management control program 1123, a federated search control program 1124, a management information acquisition control program 1125, an account correspondence management table 6100, and a search server management table 6200.

The external storage device I/F control program 1121 is a program for controlling the external storage device I/F 1130. The network I/F control program 1122 is a program for controlling the network I/F 1140. The data management control program 1123 is a program for providing a file system or a database used to manage data stored in the federated search server 1100. The federated search control program 1124 is a program including a federated search service provided by the federated search server 1100. The management information acquisition control program 1125 is a program for the federated search server 1100 to acquire management information managed by the search server 2200 that is another server constituting the federated search system 10000. The account correspondence management table 6100 is data describing a correspondence between access accounts of a user who requests the federated search and access accounts of the same user on the search servers. The search server management table 6200 is data describing network management information of the search servers.

The federated management control program 1124 includes an account information filtering control subprogram 1171, a search location filtering control subprogram 1172, a search client control subprogram 1173, and a search result federation control subprogram 1174.

When the federated search server 1100 issues a search request to the search servers, the account information filtering control subprogram 1171 executes a process of filtering the access account information, which is used by the search servers to apply security trimming to the search results, to only the access account information held by the search server 2200.

When the federated search server 1100 issues a search request to the search servers, the search location filtering control subprogram 1172 executes a process of filtering the search servers that receive the search request. Specifically, the search servers are filtered down as search targets when access accounts necessary for the search servers to access shared folders to be searched are included, among the accounts associated with the search request user.

In the search client control subprogram 1173, the federated search server 1100 issues a search request to the search servers. In the search result federation control subprogram 1174, the federated search server 1100 uses the search client control subprogram 1173 to integrate the search results acquired from the search servers.

The account correspondence management table 6100 and the search server management table 6200 will be described later.

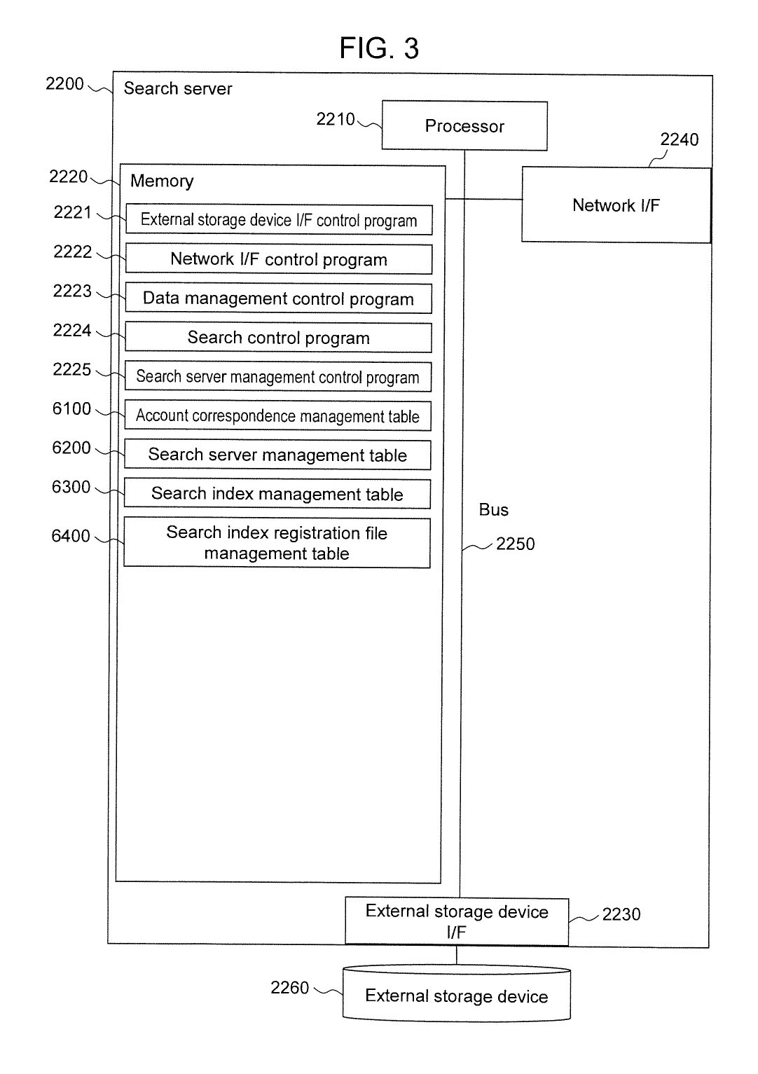

FIG. 3 is a diagram showing a hardware configuration of the search server 2200. The search server 2200 includes a processor 2210, a memory 2220, an external storage device I/F 2230, a network I/F 2240, a bus 2250, and an external storage device 2260.

The processor 2210 executes programs described below. The memory 2220 temporarily stores the programs and data described below. The external storage device I/F 2230 is an interface for accessing the external storage device 2260. The network I/F 2240 is an interface for accessing other apparatuses connected through the network 100. The bus 2250 connects the constituent elements.

The memory 2220 stores an external storage device I/F control program 2221, a network I/F control program 2222, a data management control program 2223, a search control program 2224, a search server management control program 2225, the account correspondence management table 6100, the search server management table 6200, a search index management table 6300, and a search index registration file management table 6400.

The external storage device I/F control program 2221 is a program for controlling the external storage device I/F 2230. The network I/F control program 2222 is a program for controlling the network I/F 2240. The data management control program 2223 is a program for providing a file system or a database used by the search server 2200 to manage the stored data. The search control program 2224 is a program including a file search service provided by the search server 2200. The search server management control program 2225 is a program for providing a function necessary to manage the search server 2200. The account correspondence management table 6100 and the search server management table 6200 are the same as the ones included in the federated search server 1100. The search index management table 6300 is data for managing information of the search index created by the search server 2200. The search index registration file management table 6400 is data for managing information related to files used by the search server 2200 to create the search index.

Details of the account correspondence management table 6100, the search server management table 6200, the search index management table 6300, and the search index registration file management table 6400 will be described later.

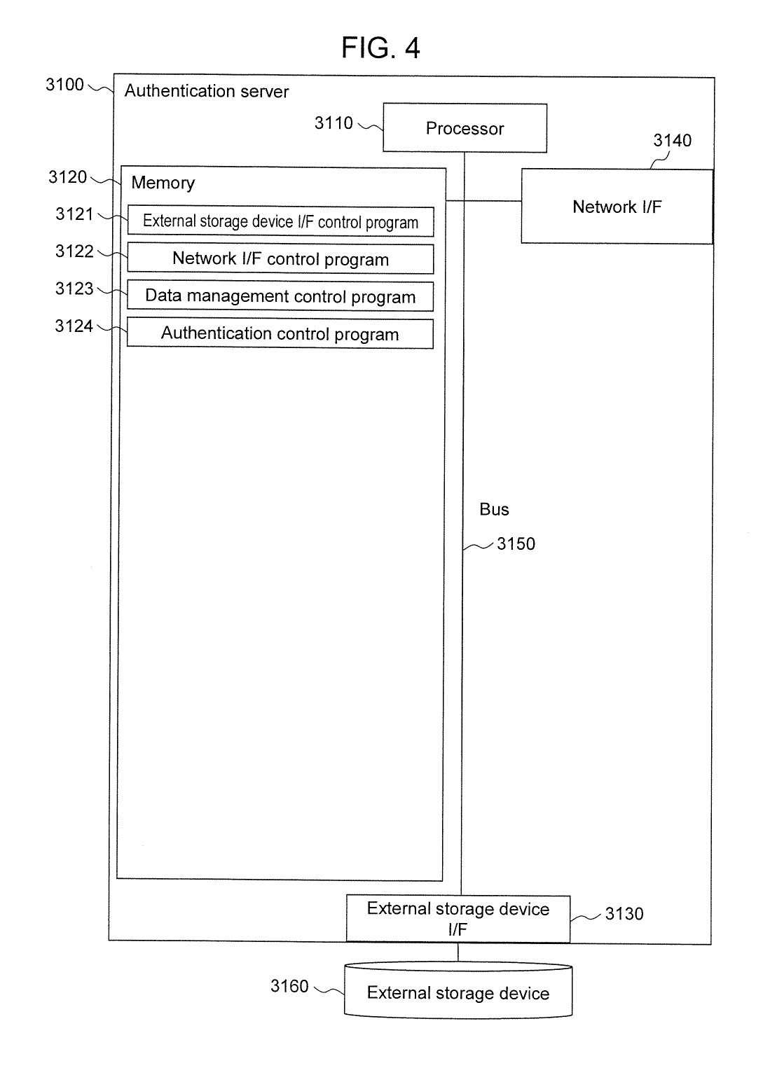

FIG. 4 is a diagram showing a hardware configuration of the authentication server 3100. The authentication server 3100 includes a processor 3110, a memory 3120, an external storage device I/F 3130, a network I/F 3140, a bus 3150, and an external storage device 3160.

The processor 3110 executes programs described below. The memory 3120 temporarily stores the programs and data described below. The external storage device I/F 3130 is an interface for accessing the external storage device 3160. The network I/F 3140 is an interface for accessing other apparatuses connected through the network 100. The bus 3150 connects the constituent elements.

The memory 3120 stores an external storage device I/F control program 3121, a network I/F control program 3122, a data management control program 3123, and an authentication control program 3124.

The external storage device I/F control program 3121 is a program for controlling the external storage device I/F 3130. The network I/F control program 3122 is a program for controlling the network I/F 3140. The data management control program 3123 is a program for providing a file system or a database used by the authentication server 3100 to manage the stored data. The authentication control program 3124 is a program including an authentication function provided by the authentication server 3100.

The authentication control program 3124 executes a process of providing information necessary in the authentication process, a process of actually authenticating the authentication target based on information presented by the authentication request source, and the like. For example, a KDC (Key Distribution Center) server used in Kerberos authentication, an LDAP (Light Weight Directory Access Protocol) server used when user information to be authenticated is managed to execute the authentication process of the user, and the like serve as the authentication control program 3124.

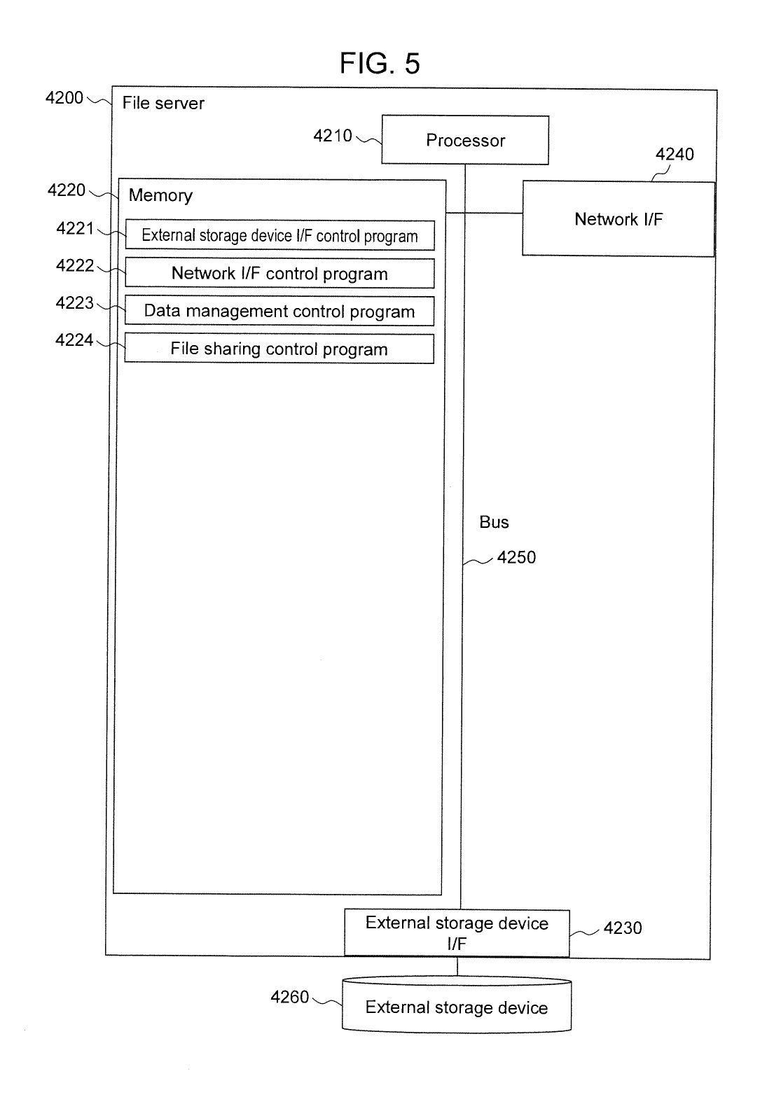

FIG. 5 is a diagram showing a hardware configuration of the file server 4200. The file server 4200 includes a processor 4210, a memory 4220, an external storage device I/F 4230, a network I/F 4240, a bus 4250, and an external storage device 4260.

The processor 4210 executes programs described below. The memory 4220 temporarily stores the programs and data described below. The external storage device I/F 4230 is an interface for accessing the external storage device 4260. The network I/F 4240 is an interface for accessing other apparatuses connected through the network 100. The bus 4250 connects the constituent elements.

The memory 4220 stores an external storage device I/F control program 4221, a network I/F control program 4222, a data management control program 4223, and a file sharing control program 4224.

The external storage device I/F control program 4221 is a program for controlling the external storage device I/F 4230. The network I/F control program 4222 is a program for controlling the network I/F 4240. The data management control program 4223 is a program for providing a file system or a database used by the file server 4200 to manage the stored data. The file sharing control program 4224 is a program including a function of providing a file sharing service for sharing files by a plurality of users.

The file sharing control program 4224 can set access control information to files stored in shared folders by the file server 4200. For example, information indicating operations permitted to the users or operations not permitted to the users can be set to each file in an ACL (Access Control List) format. The file sharing control program 4224 controls access to the files according to the access control information.

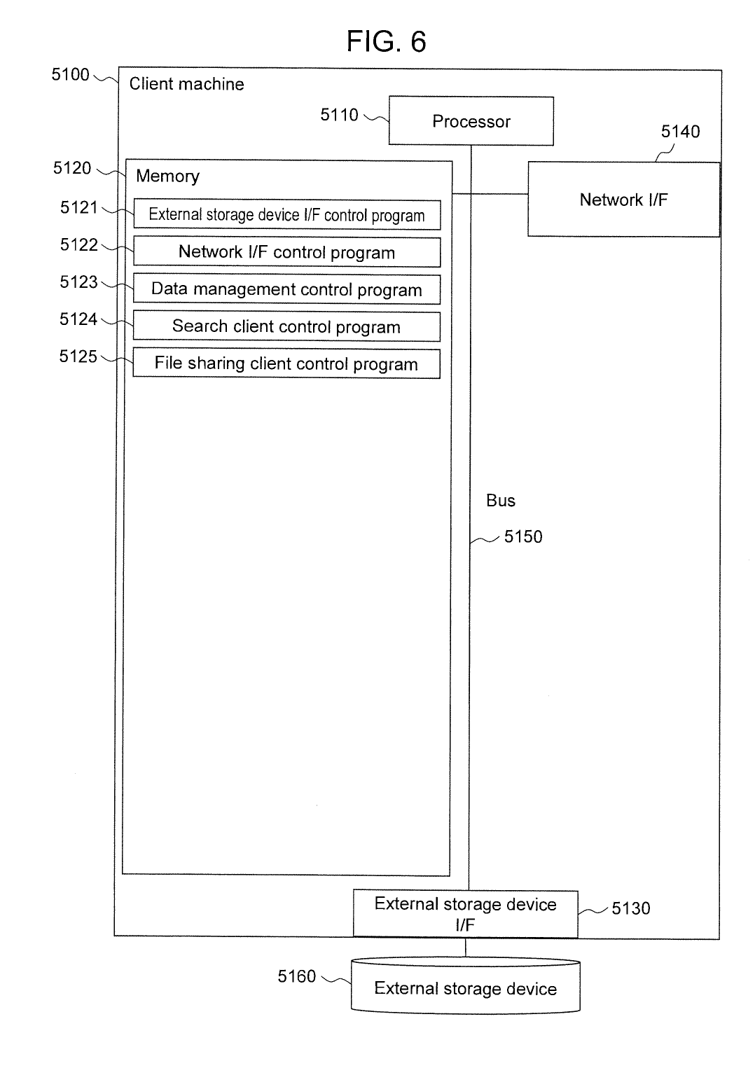

FIG. 6 is a diagram showing a hardware configuration of the client machine 5100. The client machine 5100 includes a processor 5110, a memory 5120, an external storage device I/F 5130, a network I/F 5140, a bus 5150, and an external storage device 5160.

The processor 5110 executes programs described below. The memory 5120 temporarily stores the programs and data described below. The external storage device I/F 5130 is an interface for accessing the external storage device 5160. The network I/F 5140 is an interface for accessing other apparatuses connected through the network 100. The bus 5150 connects the constituent elements.

The memory 5120 stores an external storage device I/F control program 5121, a network I/F control program 5122, a data management control program 5123, a search client control program 5124, and a file sharing client control program 5125.

The external storage device I/F control program 5121 is a program for controlling the external storage device I/F 5130. The network I/F control program 5122 is a program for controlling the network I/F 5140. The data management control program 5123 is a program for providing a file system or a database used by the client machine 5100 to manage the stored data. The search client control program 5124 is a program used for accessing the federated search server 1100 or the search server 2200 from the client machine 5100. The file sharing client control program 5125 is a program used to access files shared and disclosed by the file server 4200 from the client machine 5100.

The search client control program 5124 is a program for providing a function compliant to specifications provided by the federated search server 1100 or the search server 2200. For example, the search client control program 5124 may be loaded as a Web client that uses a Web application program for search server, or the search client control program 5124 may be loaded using a general-purpose Web browser.

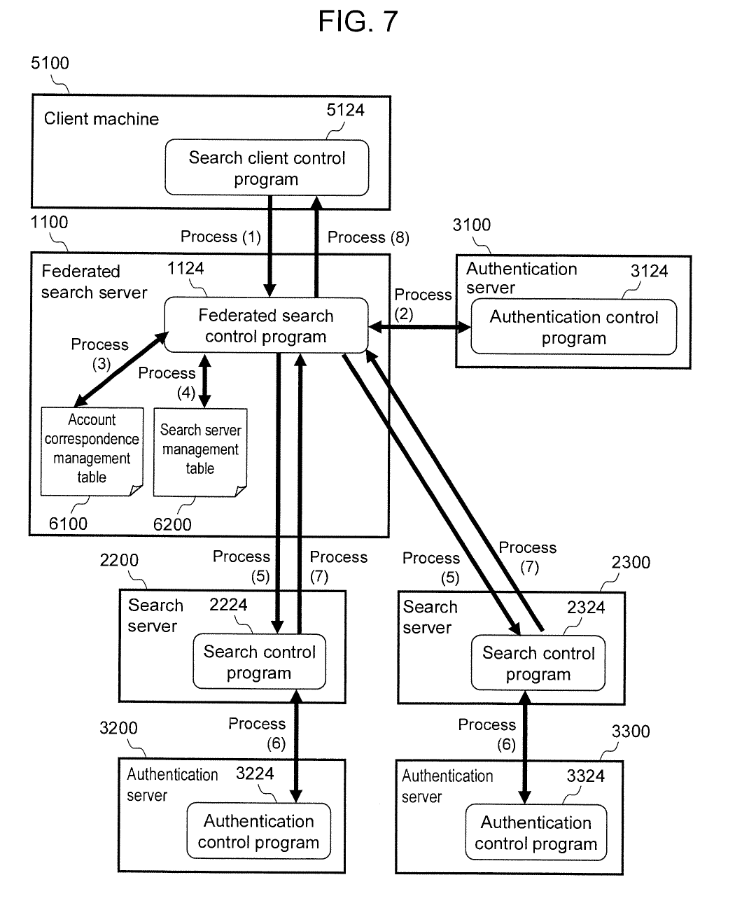

FIG. 7 is a diagram showing flows of a process executed in the federated search server 1100 and various processes executed between the servers when the user issues a federated search request from the client machine 5100 to the federated search server 1100. Steps of FIG. 7 will be described.

### (FIG. 7: Process (1))

The user of the client machine 5100 uses the search client control program 5124 of the client machine 5100 to designate search conditions and issues the federated search request to the federated search server 1100.

### (FIG. 7: Process (2))

The federated search control program 1124 of the federated search server 1100 requests the authentication server 3100 for an authentication process to execute the authentication process of the user who has requested the federated search. The authentication server 3100 executes the authentication control program 3124 to execute the authentication process. The federated search control program 1124 receives the result of the authentication.

### (FIG. 7: Process (3))

If the authentication is successful in the process (2), the federated search control program 1124 refers to the account correspondence management table 6100 managed by the federated search server 1100 to acquire a list of access account information associated with the user who has requested the federated search.

### (FIG. 7: Process (4))

The federated search control program 1124 refers to the search server management table 6200 managed by the federated search server 1100 to acquire a list of the search servers belonging to the same network domains as those of the access accounts acquired in the process (3). The correspondence between the access accounts and the search servers will be described again later with reference to FIG. 11.

### (FIG. 7: Process (5))

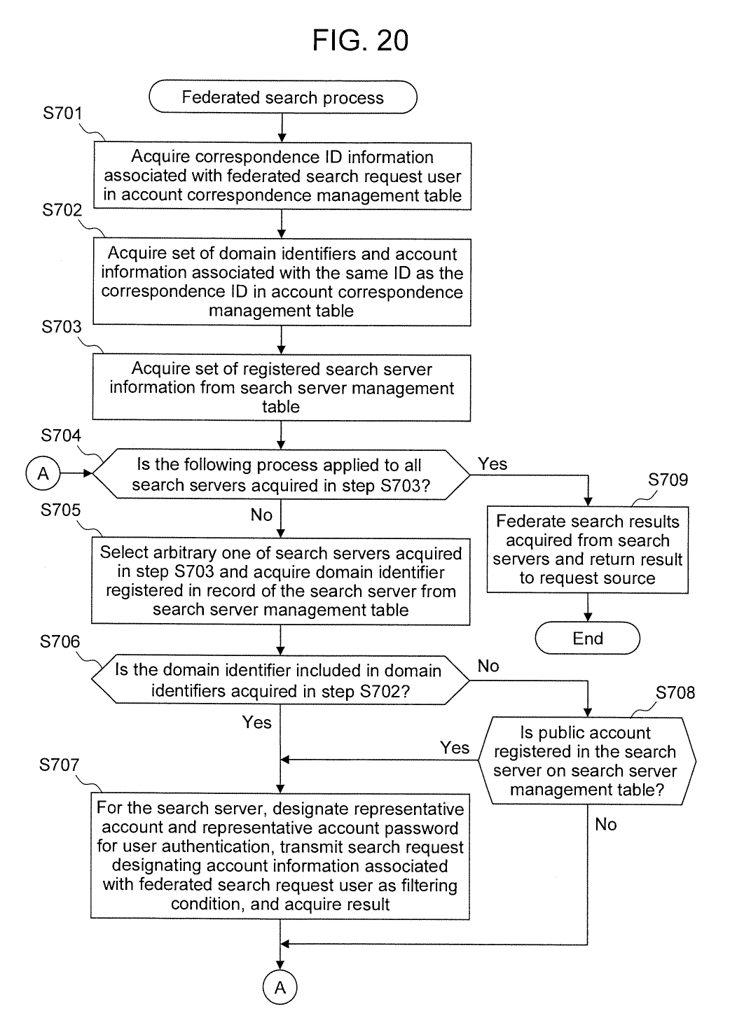

The federated search control program 1124 issues a search request to the search servers 2200 and 2300 acquired from the list in the process (4). In the search request issued by the federated search control program 1124 in the present step, the access account used for log-on authentication in requesting the search servers for the search is a representative user account described later. However, the range that the associated access accounts acquired in the process (3) have an access right is designated as a search condition. Details will be described again later with reference to FIG. 20.

### (FIG. 7: Process (6))

The search control program 2224 of the search server 2200 requests the authentication server 3200 for an authentication process to execute the authentication process of the user who has issued the search request in the process (5). The authentication server 3200 executes the authentication process based on the authentication control program 3224. The search control program 2224 receives the result of the authentication.

### (FIG. 7: Process (7))

If the authentication is successful in the process (6), the search control program 2224 uses the search index information managed by the search server 2200 to execute the search based on the designated search conditions, uses the access account information designated in the search conditions to carry out the security trimming, and returns the search result to the request source.

### (FIG. 7: Processes (5) to (7): Supplement)

The processes (5) to (7) are similarly executed for the other search servers that are search targets such as the search server 2300.

### (FIG. 7: Process (8))

After receiving the search results from all search servers to which the search request is issued, the federated search control program 1124 of the federated search server 1100 federates the search results received from the search servers and returns the federated search result to the search request source. The processes can realize the federated search.

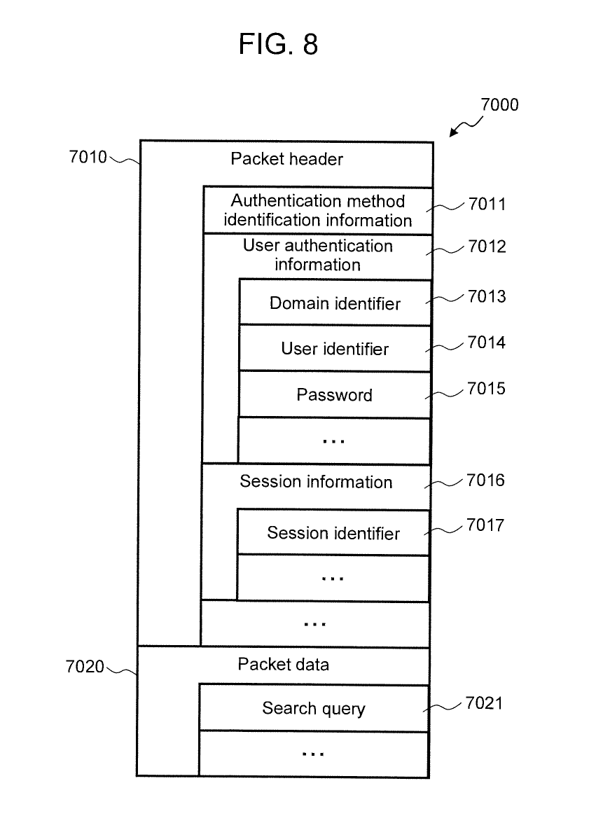

FIG. 8 is a diagram showing a data structure of a federated search request packet 7000. The federated search request packet 7000 is a communication packet for transmitting the content of the request to the federated search control program 1124 when the federated search request is issued from the search client control program 5124 to the federated search control program 1124.

The federated search request packet 7000 includes a packet header 7010 and packet data 7020.

The packet header 7010 includes authentication method identification information 7011, user authentication information 7012, and session information 7016.

The authentication method identification information 7011 describes information for designating an authentication method when the authentication process is executed between the search client control program 5124 and the federated search control program 1124. The federated search control program 1124 executes the user authentication process according to the authentication method designated by the authentication method identification information 7011. The authentication method identification information 7011 may be statically designated between the search client control program 5124 and the federated search control program 1124, or a negotiation process for determining the authentication method between the programs may be separately executed prior to the federated search request.

The user authentication information 7012 holds information necessary to specify the user to be authenticated in the authentication method designated by the authentication method identification information 7011. For example, the user authentication information 7012 stores a domain identifier 7013 for indentifying authentication domains that manage access accounts to be authenticated, a user identifier 7014 for identifying the user, a password 7015 as means for certifying the target user, and the like. The user authentication information 7012 may separately define necessary information for each authentication method designated by the authentication method identification information 7011.

The session information 7016 stores information for specifying the result of the authentication process executed by the federated search control program 1124 when the search client control program 5124 has issued the federated search request in the past. For example, the session information 7016 stores a session identifier 7017 and the like issued by the federated search control program 1124 when the user authentication is successful.

The federated search control program 1124 internally stores the identification information of the target user with successful authentication when the session identifier 7017 is issued. When the search client control program 5124 designates the session identifier 7017 to issue the federated search request, the federated search control program 1124 specifies the user who has issued the federated search request based on the internally stored identification information of the user and skips the authentication process for the user to execute the federated search process.

As a result of using the session identifier 7017, the search client control program 5124 does not have to transmit the user authentication information every time the federated search request is issued. Whether to use the session information 7016 is optional, and the session information 7016 does not necessarily have to be used. When the session information 7016 is not used, the authentication method identification information 7011 and the user authentication information 7012 can be used to authenticate the user.

The packet data 7020 holds a search query 7021 and the like. The search query 7021 describes search conditions in the federated search request. Examples of the search conditions that can be designated include search keywords (character strings) included in the target files, file creators included in metadata of the target files, file update date/time, and a combination of these.

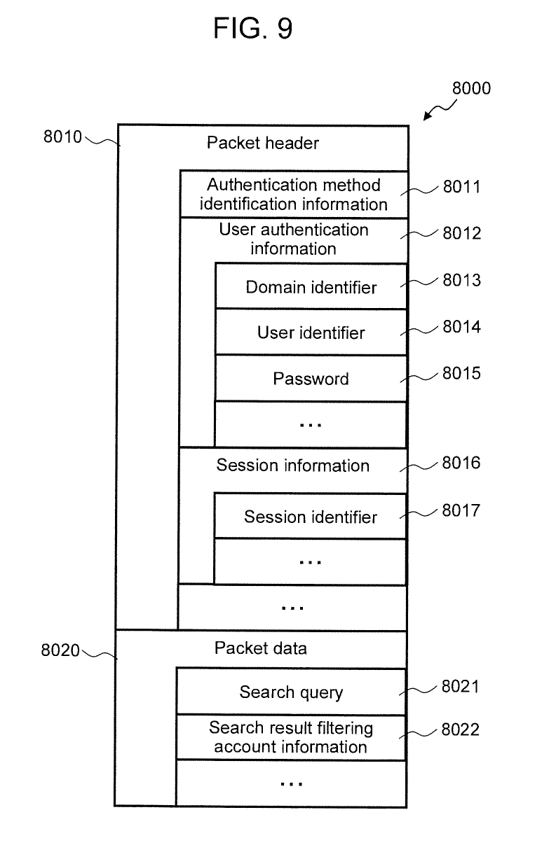

FIG. 9 is a diagram showing a data structure of the search request packet 8000. The search request packet 8000 is a communication packet for transmitting the content of the request to the search control program 2224 when the search request is issued from the federated search control program 1124 to the search control program 2224 of the search server 2200.

The search request packet 8000 includes a packet header 8010 and packet data 8020. The packet header 8010 is the same as the packet header 7010 in the federated search request packet 7000, and the description will not be repeated.

The packet data 8020 holds a search query 8021, search result filtering account information 8022, and the like. The search query 8021 describes search conditions in the federated search request. Examples of the search conditions that can be designated include search keywords (search character strings) included in the target files, file creators included in metadata of the target files, file update date/time, and a combination of these. The search result filtering account information 8022 is used as a condition for filtering files for which the access accounts designated in the field have rights to refer to, among the files that meet the search conditions designated by the search query 8021.

In the security trimming of the search result, the search control program 2224 may use the access account information designated by the search result filtering account information 8022, may use the access account information corresponding to the user designated in the packet header 8010 of the search request packet 8000, or may use a combination of these.

As a result of using the search result filtering account information 8022, for example, a common access account can be used for search requests from a plurality of users to carry out the search. In this case, the search result filtering account information 8022 is designated as a condition of the security trimming. In this way, one session established between the federated search control program 1124 and the search control program 2224 can be shared in the search requests from the plurality of users, and the number of communication sessions can be reduced. The reduction in the number of communication sessions can reduce the amount of session information that needs to be managed by the search control program 2224 and reduce the memory utilization volume.

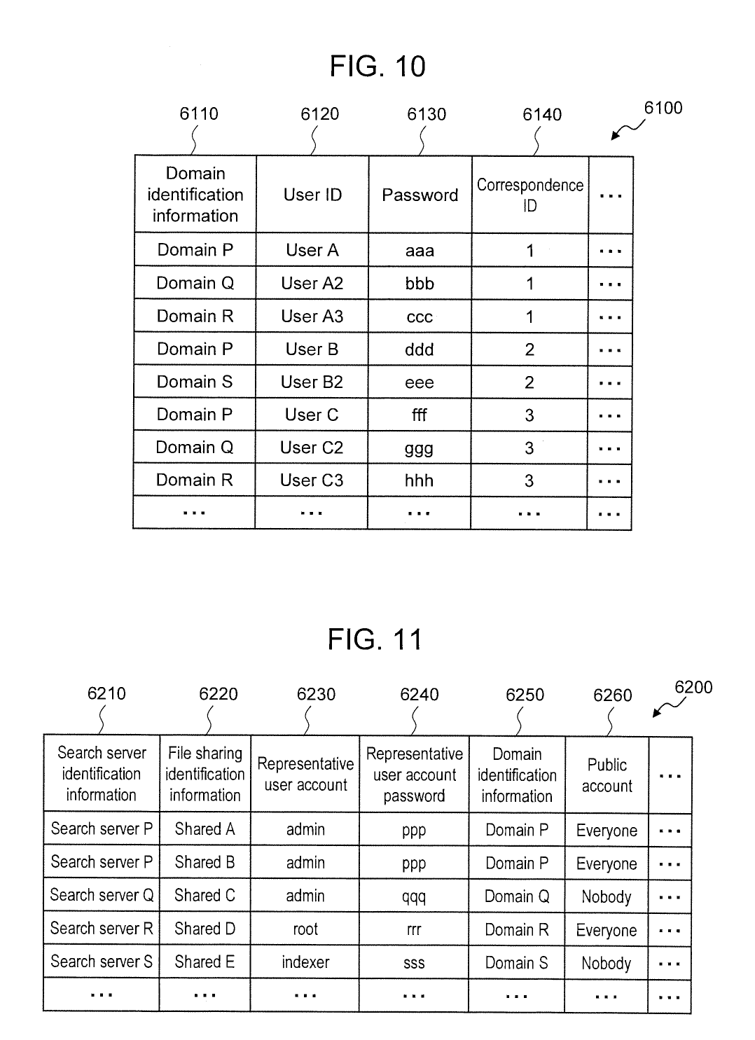

FIG. 10 is a diagram showing a configuration and an example of data of the account correspondence management table 6100. The account correspondence management table 6100 manages the account information associated with the users registered in the federated search server 1100 to perform security trimming of the search results in the federated search service provided by the federated search server 1100.

When the federated search request is received, the federated search server 1100 can specify the user who has issued the federated search request and can refer to the account correspondence management table 6100 to acquire a list of the access account information associated with the user. More specifically, the federated search server 1100 can acquire a list of the access accounts that the user who has issued the federated search request has in other network domains and can designate the access accounts as the search conditions when issuing the search request to the search servers. This can also be interpreted as meaning that the access accounts that have issued the federated search request are converted to the access accounts in the search servers.

If the search servers 2200 and 2300 include account correspondence management tables, the search servers can similarly convert the access accounts. Therefore, although the federated search server 1100 primarily converts the access accounts, the search servers can alternatively convert the access accounts.

The account correspondence management table 6100 includes domain identification information 6110, a user ID 6120, a password 6130, and a correspondence ID 6140.

The domain identification information 6110 stores information for identifying the network domains to which the access accounts held by the user ID 6120 belong. The information may be character strings or identification numbers for identifying the network domains or may be identification information of the authentication servers that manage the network domains.

The user ID 6120 holds access account information for identifying the users. The information may be arbitrary character strings, identification numbers, or the like for identifying the users. Other than the information for identifying the users, the information held by the user ID 6120 may store group identification information including a plurality of users.

The password 6130 holds information for certifying that the user is identified by the access account information held by the user ID 6120. For example, the password 6130 holds password character strings and certifications used to carry out the user authentication. The information held by the password 6130 may be encrypted if necessary to prevent the leak of information.

The correspondence ID 6140 stores identification information indicating a correspondence between pieces of access account information registered in the account correspondence management table 6100. The access accounts with the same value of the correspondence ID 6140 are associated to each other. More specifically, the access accounts possessed by the same user on the network domains are designated with the same value of the correspondence ID 6140. In the example shown in FIG. 10, users A to A3 actually indicate access accounts of the same user.

FIG. 11 is a diagram showing a configuration and an example of data of the search server management table 6200. The search server management table 6200 manages information such as network domains to which the search servers belong, shared folders accessed by the search servers, and the like. The shared folders denote folders shared by the servers in order for the file servers to disclose files. The search servers need to figure out the locations and necessary access rights of the shared folders to search for the files stored in the shared folders.

The search server management table 6200 included in the search server 2200 manages only the information related to the search server 2200, and the search server management table 6200 included in the federated search server 1100 collectively manages the information related to all search servers used in the federated search. FIG. 11 illustrates the search server management table 6200 included in the federated search server 1100.

When the federated search request is received, the federated search server 1100 can refer to the search server management table 6200 of the federated search server 1100 to acquire a list of the search servers that can be destinations of the search request. In the creation or update of the search index, the search server 2200 can refer to the search server management table 6200 of the search server 2200 to collectively acquire the information related to the shared folders to be searched.

The search server management table 6200 includes search server identification information 6210, file sharing identification information 6220, a representative user account 6230, a representative user account password 6240, domain identification information 6250, and a public account 6260.

The search server identification information 6210 stores identification information of the search servers. The information may be arbitrary character strings or identification numbers for indentifying the search servers or may be information such as host names and IP addresses necessary to access the search servers. In principle, the search server management table 6200 included in the search server 2200 holds only information for identifying the search server 2200.

The file sharing identification information 6220 stores information for identifying the shared folders held by the search servers identified by the values of the search server identification information 6210. Since shared names are usually provided to the shared folders, the shared names can be stored. The information may be arbitrary character strings or identification numbers for identifying the shared folders or may be character strings such as URLs formed by host names, path names, and the like necessary to access the shared folders. If one search server includes a plurality of shared folders, a plurality of pieces of the information may be arranged for the same search server. FIG. 11 shows an example in which a search server P includes two shared folders.

The representative user account 6230 holds information of the access accounts with rights to access the search target files stored in the shared folders identified by the values of the file sharing identification information 6220. The information is used by the search server to create a search index for searching for the files in the shared folders. The files stored in the shared folders may not be disclosed to all users. Therefore, the access accounts with access rights to all files are used to create the search index.

The representative user account password 6240 holds information for certifying the representative users identified by the values of the representative user account 6230. For example, the representative user account password 6240 holds password character strings, certificates, and the like used to authenticate the users. The information held by the representative user account password 6240 may be encrypted if necessary to prevent the leak of information.

The domain identification information 6250 holds information for identifying the network domains to which the search servers identified by the values of the search server identification information 6210 belong. The information may be arbitrary character strings or identification numbers for identifying the network domains or may be identification information of the authentication servers that manage the network domains.

The public account 6260 stores information of public access accounts that can access only the files without access control on the shared folders identified by the values of the file sharing identification information 6220. For example, an everyone account, an anonymous account, and a nobody account are the public access accounts. The use of the public access accounts can provide a search result including files that meet the search conditions among the files without access control, even if a search request is received from a user who does not have an access right to the shared folders. The passwords are generally unnecessary when the shared folders are accessed by the public access accounts. If the passwords are separately necessary, the passwords may be further added and described in the search server management table 6200.

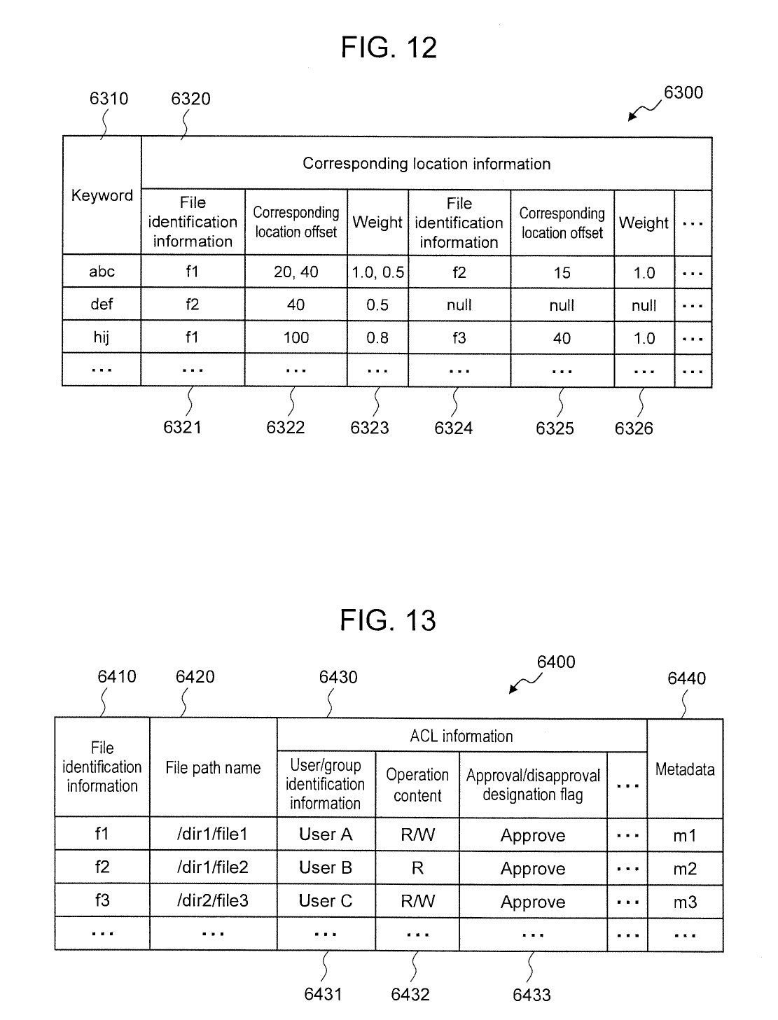

FIG. 12 is a diagram showing a configuration and an example of data of the search index management table 6300 included in the search server 2200. The search index management table 6300 manages information of the search index created by the search server 2200. The search index management table 6300 includes a keyword 6310 and corresponding location information 6320.

The keyword 6310 stores character strings obtained by analyzing the files to be searched by an indexing process. The corresponding location information 6320 registers information related to the files including the character strings written by the keyword 6310.

The corresponding location information 6320 further includes file identification information 6321 and 6324, corresponding location offsets 6322 and 6325, and weights 6323 and 6326.

The file identification information 6321 and 6324 hold information for identifying the files including the keyword character strings written by the keyword 6310. Specifically, information registered in file identification information 6410 in the search index registration file management table 6400 described later may be registered, or file path names and file identifiers for actually accessing the target files may be registered.

The corresponding location offsets 6322 and 6325 register offset information indicating locations of the keyword character strings written in the keyword 6310 in the files designated by the file identification information 6321 and 6324. When the keyword character strings written by the keyword 6310 appear at a plurality of sections within one file, the corresponding location offsets 6322 and 6325 register a plurality of pieces of the offset information.

The weights 6323 and 6326 register values of importance of the appearance of the keyword character strings written by the keyword 6310 at the offset locations designated by the file identification information 6321 and 6324. The search server 2200 appropriately sets the values. A greater value indicates greater importance. The values can be used to filter or align the search results.

A plurality of pieces of the corresponding location information 6320 may be able to be registered for one keyword 6310. This can handle a case with a plurality of files corresponding to the keyword character string. A null value indicating that the record is invalid can also be registered in the corresponding location information 6320. The null values can be used to fill in blank items in a record with fewer items than other records.

FIG. 13 is a diagram showing a configuration and an example of data of the search index registration file management table 6400 included in the search server 2200. The search index registration file management table 6400 manages information related to files that are targets of the creation of the search index by the search server 2200 and that are acquired from the shared folders on the file server 4200.

The search index registration file management table 6400 includes the file identification information 6410, a file path name 6420, ACL information 6430, and metadata 6440.

The file identification information 6410 denotes identifiers for uniquely identifying the files acquired by the search server 2200 to create the search index. The identifiers may be serial numbers provided by the search server 2200 or may be serial numbers provided to the files by the file server 4200. Other than the serial numbers, appropriate character strings that can be used to identify the files may be used.

The file path name 6420 is equivalent to a file path name storing a file. The search server 2200 can designate the file path name 6420 to issue a file acquisition request to acquire the file.

The ACL information 6430 is equivalent to ACL information acquired as an element of metadata when the target files are indexed. The ACL information 6430 includes user/group identification information 6431, operation content 6432, and an approval/disapproval designation flag 6433. A user or a group designated by the user/group identification information 6431 is permitted or not permitted with an operation designated by the operation content 6432 in accordance with a flag designated by the approval/disapproval designation flag 6433.

The operation content 6432 may be individually defined based on an ACL format defined by the file server 4200 or may be designated based on a general-purpose ACL format. For example, in FIG. 13, “R” in the operation content 6432 denotes a READ access, and “W” denotes a WRITE access. Obviously, the format does not necessarily have to be followed, and other formats may be used.

Access control with a combination of a plurality of conditions can be performed by registering a plurality of sets of the user/group identification information 6431, the operation content 6432, and the approval/disapproval designation flag 6433.

The metadata 6440 stores metadata acquired when the target files are indexed.

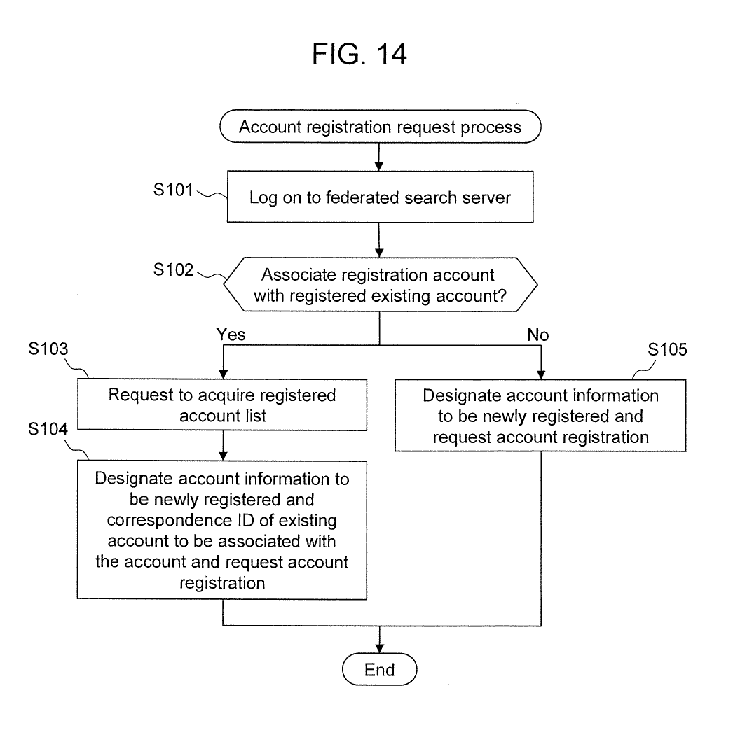

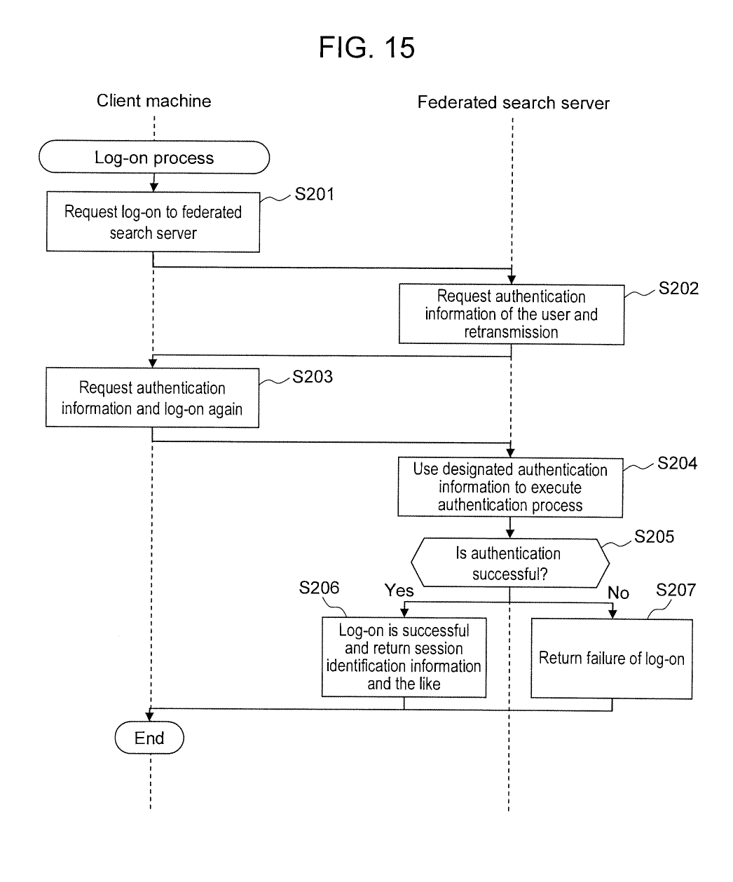

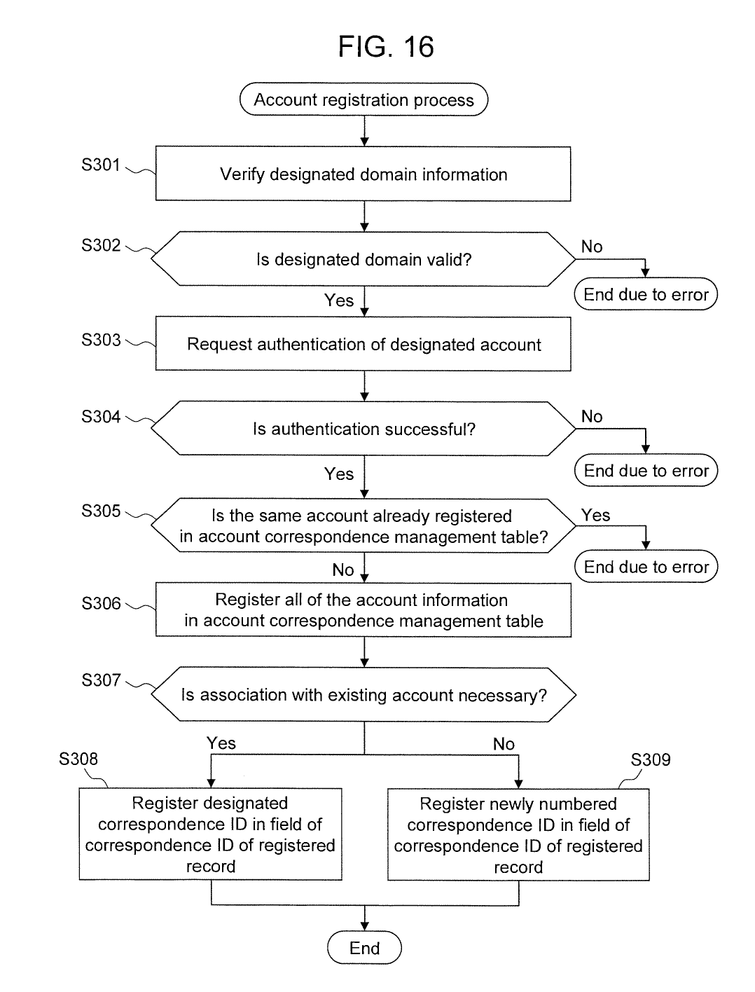

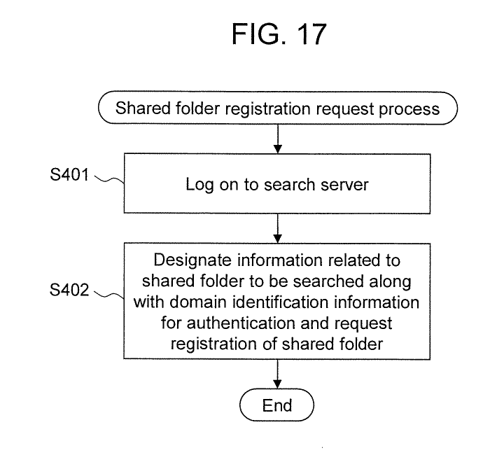

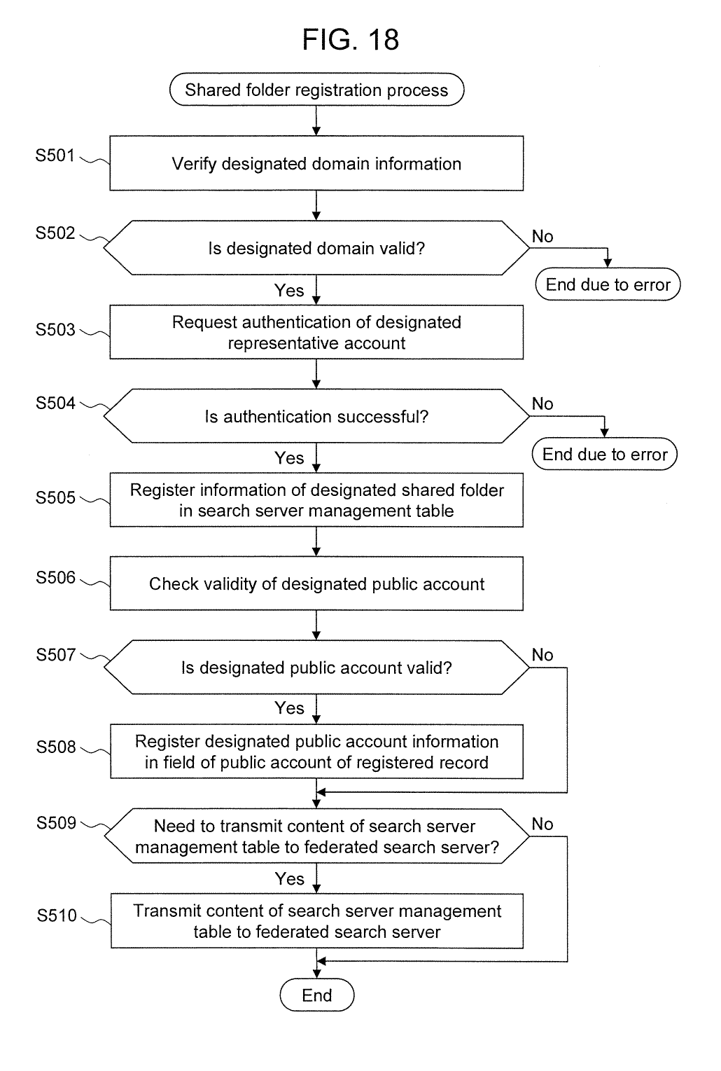

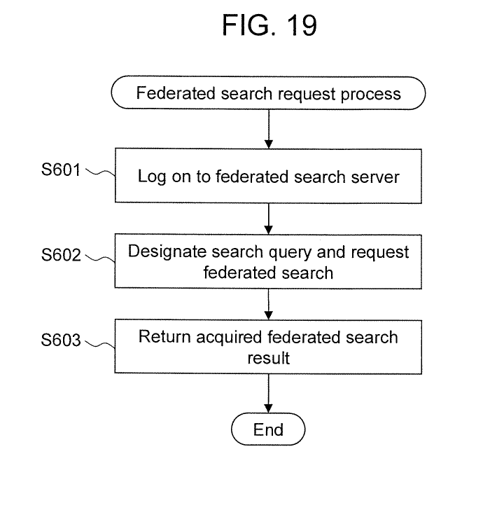

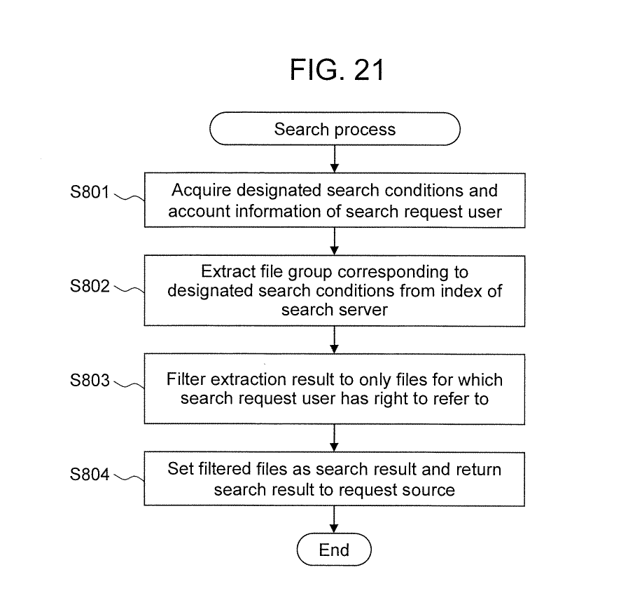

The configuration of the federated search system 10000, the data structure of the packet, and the configuration of the management information have been described. Hereinafter, a processing procedure of the federated search system 10000 will be described. An account registration request process (FIG. 14), a log-on process (FIG. 15), an account registration process (FIG. 16), a file sharing registration request process (FIG. 17), a file sharing registration process (FIG. 18), a federated search request process (FIG. 19), a federated search process (FIG. 20), and a search process (FIG. 21) will be described.

FIG. 14 shows a flow of a process of requesting to register an access account from the client machine 5100 to the federated search server 1100 or the search server 2200. To use the federated search service, a correspondence between the access account that requests the federated search and the access accounts on the search servers needs to be registered in advance on the federated search server 1100. An example of a process in which the system administrator requests the federated search server 1100 to register an access account will be described. The content is the same as in a process of requesting the search server 2200 to register an access account.

### (FIG. 14: Step S101)

The system administrator uses the client machine 5100 to log on to the federated search server 1100. The federated search server 1100 authenticates the user who has requested the log-on. A flow of the long-on process will be described later. Other than using the client machine 5100, a dedicated machine for system management may be used.

### (FIG. 14: Step S102)

After logging on to the federated search server 1100, the system administrator selects whether the federated search server 1100 will associate the access account to be newly registered with the registered existing accounts. If the system administrator selects to associate the accounts, the process proceeds to step S103. If the system administrator selects not to associate the accounts, the process proceeds to step S105.

### (FIG. 14: Step S103)

The system administrator requests the federated search server 1100 to acquire a list of the registered accounts. When the request is received, the federated search server 1100 acquires the account list stored in the account correspondence management table 6100 and provides the account list to the client machine 5100. The account list includes the correspondence ID 6140 stored in the account correspondence management table 6100.

### (FIG. 14: Step S104)

After acquiring the account list transmitted by the federated search server 1100, the system administrator selects, from the account list, the correspondence ID 6140 to be associated with the access account to be newly registered. The system administrator designates the association and then requests the federated search server 1100 to register the new access account. The network domain to which the access account to be newly registered or associated belongs may also be designated together. The same applies to step S105. A flow of the process by the federated search server 1100 to register the access account will be described later.

### (FIG. 14: Step S105)

The system administrator designates access account information to be newly registered and requests the federated search server 1100 to register the access account.

### (FIG. 14: Steps S101 to S105: Supplement)

In the process shown in FIG. 14, pieces of the access account information can be registered one by one. In place of this, a script program or the like may be used to repeatedly execute the process of FIG. 14 to register the plurality of pieces of access account information. A format following the flow of the process shown in FIG. 14 may be used to provide a function of designating and collectively registering the plurality of pieces of new access account information. The data included in the account correspondence management table 6100 shown in FIG. 10 may be able to be designated as a registration target to handle the collective registration.

FIG. 15 is a diagram showing a flow of the log-on process in processing step S101 of FIG. 14. Hereinafter, an example of a process in which a general user who requests the log-on uses the client machine 5100 to request the federated search server 1100 for the log-on will be described. The content of the process when the system administrator logs on and the content of the log-on process for the search server 2200 are also the same.

### (FIG. 15: Step S201)

The user who requests the log-on uses the client machine 5100 to request the federated search server 1100 for the log-on process. Information related to candidates of an authentication system that can be used by the client machine 5100 may be transmitted in the request.

### (FIG. 15: Step S202)

When the log-on process request is received in step S201, the federated search server 1100 asks the user who has requested the log-on to transmit the authentication information of the user. In this query, information related to the authentication systems that can be handled by the federated search server 1100 may be included.

### (FIG. 15: Step S203)

The user who has requested the log-on inputs the authentication information of the user and requests the log-on process again. If the authentication system is determined in steps S201 and S202, the authentication information input here corresponds to the system.

### (FIG. 15: Step S204)

When the log-on process request provided with the authentication information is received, the federated search server 1100 uses the designated authentication information to execute the authentication process. The authentication process executed here may be internally executed by the federated search server 1100 or may be executed in cooperation with the external authentication server 3100 or the like.

### (FIG. 15: Step S205)

The federated search server 1100 checks whether the authentication process is successful. If the authentication process is successful, the process proceeds to step S206. If the authentication process has failed, the process proceeds to step S207.

### (FIG. 15: Step S206)

The federated search server 1100 returns, to the client machine 5100, a response indicative of the success of the log-on along with session identification information and the like. An example of the session identification information includes a session identifier. The federated search server 1100 may issue a session identifier associated with the access account information of the user who has requested the log-on and internally manage the association information.

### (FIG. 15: Step S207)

The federated search server 1100 returns, to the client machine 5100, a response indicative of the failure of the log-on.

FIG. 16 is a diagram showing a flow of the access account registration process in steps S104 and S105 of FIG. 14. Hereinafter, an example of a process in which the federated search server 1100 registers an access account will be described. The content of the process of registering an access account by the search server 2200 is also the same.

### (FIG. 16: Step S301)

When the request for registering the access account is received in step S104 or S105, the federated search server 1100 verifies registration location network domain information designated in the request. For example, based on the designated network domain identification information 6120, the federated search server 1100 checks whether an authentication server that manages the network domain exists and is in operation.

### (FIG. 16: Step S302)

After verifying the network domain, the federated search server 1100 checks whether the designated network domain is valid based on the verification result. If the designated network domain is invalid, the process is finished due to an error. If the designated network domain is valid, the process proceeds to step S303.

### (FIG. 16: Step S303)

The federated search server 1100 authenticates the access account designated to be registered. A predetermined authentication process is executed when the federated search server 1100 executes the authentication process. When an external authentication server is used to execute the authentication process, the authentication process is requested to the authentication server, and the result of the authentication is acquired.

### (FIG. 16: Step S304)

After executing the process of authenticating the access account, the federated search server 1100 checks whether the authentication process is successful. If the authentication has failed, the process is finished due to an error. If the authentication is successful, the process proceeds to step S305.

### (FIG. 16: Step S305)

The federated search server 1100 refers to the account correspondence management table 6100 to check whether the access account designated to be registered is already registered. If the access account is already registered, the processing flow is finished due to an error. Alternatively, the existing access account information may be mandatorily overwritten and updated without finishing the process due to an error. If the access account is not registered, the process proceeds to step S306.

### (FIG. 16: Step S306)

The federated search server 1100 creates a new record in the account correspondence management table 6100 and registers the access account information requested to be registered. However, nothing is registered in the field of the correspondence ID 6140 in the account correspondence management table 6100 at this point.

### (FIG. 16: Step S307)

Based on the result of step S102, the federated search server 1100 checks whether there is a need to associate the access account requested to be registered with the existing access accounts. If the association is necessary, the process proceeds to step S308. If the association is not necessary, the process proceeds to step S309.

### (FIG. 16: Step S308)

The federated search server 1100 registers the same value as the correspondence ID 6140 of the access account to be associated, in the field of the correspondence ID 6140 of the record in the account correspondence management table 6100 newly registered in step S306.

### (FIG. 16: Step S309)

The federated search server 1100 registers a newly numbered correspondence ID in the field of the correspondence ID 6140 of the record newly registered in the account correspondence management table 6100 in step S306.

### (FIG. 16: Steps S301 to S309: Supplement)

In accordance with the flow of the process described above, a process of updating the information registered in the account correspondence management table 6100 can be implemented, and a process of deleting the registered account can be implemented.

FIG. 17 shows a flow of a process in which the client machine 5100 requests the search server 2200 to register the shared folder to be searched in the search server 2200. Hereinafter, an example of a process in which the system administrator requests the search server 2200 to register the shared folder will be described.

### (FIG. 17: Step S401)

The system administrator uses the client machine 5100 to log on to the search server 2200. The content of the log-on process is the same as the content described in FIG. 15. Other than using the client machine 5100, a dedicated machine for system management may be used.

### (FIG. 17: Step S402)

After logging on to the search server 2200, the system administrator designates information related to the shared folder to be searched and requests the search server 2200 to register the shared folder. The information designated here includes file sharing identification information 6220, the representative user account 6230, the representative user account password 6240, the domain identification information 6250, and the public account 6260 in the information included in the search server management table 6200. The domain identification information 6250 stores information for identifying the network domain used by the file server 3100 in the file access control when a file on the shared folder to be registered is accessed. A flow of the process of registering the shared folder by the search server 2200 will be described later.

### (FIG. 17: Steps S401 and S402: Supplement)

In the process shown in FIG. 17, pieces of the information related to the shared folders can be registered one by one. A script program and the like can be used to repeatedly execute the process to register the information related to a plurality of shared folders. A function of designating the information related to a plurality of shared folders to collectively register the information in a format following the flow of the process shown in FIG. 17 may be provided. The data included in the search server management table 6200 shown in FIG. 11 can be designated as a registration target to handle the collective registration.

FIG. 18 is a diagram showing a flow of the process in step S402 of FIG. 17. Hereinafter, an example of a process of registering the shared folder by the search server 2200 will be described.

### (FIG. 18: Step S501)

When the request for registering the shared folder is received, the search server 2200 verifies the designated network domain information. For example, based on the designated network domain identification information 6250, the search server 2200 checks whether an authentication server that manages the network domain exists and in operation.

### (FIG. 18: Step S502)

After the check in step S501, the search server 2200 examines whether the designated network domain is valid based on the result of the check. If the designated network domain is invalid, the process is finished due to an error. If the designated network domain is valid, the process proceeds to step S503.

### (FIG. 18: Step S503)

The search server 2200 authenticates the designated representative user account. Here, the search server 2200 requests an external authentication server, which authenticates the user who accesses the designated shared folder, for the authentication process. Instead of requesting the authentication server for the authentication process, the search server 2200 may actually attempt accessing the shared folder based on the designated access account information and may determine that the authentication is successful if the access is successful. In this case, a similar result can be obtained, because the file server 4200 that provides the shared folder issues an authentication request to the authentication server 3200.

### (FIG. 18: Step S504)

The search server 2200 examines whether the authentication process is successful. If the authentication has failed, the process is finished due to an error. If the authentication is successful, the process proceeds to step S505.

### (FIG. 18: Step S505)

The search server 2200 registers information related to the shared folder in the search server management table 6200. However, nothing is registered in the field of the public account 6260 in the search server management table 6200 at this point.

### (FIG. 18: Steps S506 and S507)

After registering the information related to the shared folder, the search server 2200 checks the validity of the designated public account in accordance with the registered content. The search server 2200 may actually attempt accessing the shared folder based on the designated public account information and may determine that the public account is valid if the access is successful. If the public account is valid, the process proceeds to step S508. If the public account is not valid, the process skips to step S509.

### (FIG. 18: Step S508)

The search server 2200 registers the designated public account information in the field of the public account 6260 of the record newly registered in the search server management table 6200 in step S505.

### (FIG. 18: Step S509)

After executing the process related to the public account, the search server 2200 examines whether the content of the search server management table 6200 needs to be transmitted to the federated search server 1100. If the content needs to be transmitted, the process proceeds to step S510. If the content does not need to be transmitted, the processing flow is finished.

### (FIG. 18: Step S509: Supplement)

In the present step, the timing of the transmission of the information of the search server management table 6200 to the federated search server 1100 may be able to be set for each search server. For example, the information may be transmitted to the federated search server 1100 every time the search server management table 6200 is updated, or the information may not be transmitted. A daemon program or the like may be separately prepared to provide a function of periodically transmitting the content of the update to the federated search server 1100. In the present step, the search server 2200 determines that the content of the search server management table 6200 needs to be transmitted if predetermined transmission timing has come.

### (FIG. 18: Step S510)

The search server 2200 transmits the information stored in the search server management table 6200 of the search server 2200 to the federated search server 1100. The federated search server 1100 reflects the received information on the search server management table 6200 of the federated search server 1100.

### (FIG. 18: Steps S501 to S510: Supplement)

In accordance with the flow of the process described above, a process of updating the information registered in the search server management table 6200 can be implemented, and a process of deleting the registered shared folder information can be implemented.

FIG. 19 is a diagram showing a flow of a process of requesting federated search from the client machine 5100 to the federated search server 1100. Hereinafter, steps of FIG. 19 will be described.

### (FIG. 19: Step S601)

The user who requests the federated search uses the search client control program 5124 on the client machine 5100 to log on to the federated search server 1100. The content of the log-on process is the same as the content described in FIG. 15.

### (FIG. 19: Step S602)

After the log-on by the user, the search client control program 5124 acquires the search conditions such as the search keyword, and based on the acquired search conditions, creates a search query that can be interpreted by the federated search server 1100. The search client control program 5124 uses the search query to transmit the federated search request to the federated search server 1100. A flow of a federated search process in the federated search server 1100 will be described later.

### (FIG. 19: Step S603)

The federated search server 1100 carries out the federated search and transmits the result to the client machine 5100. The search client control program 5124 acquires the federated search result. After acquiring the federated search result, the search client control program 5124 returns the federated search result to the user and finishes the process.

FIG. 20 is a diagram showing a flow of the federated search process in step S602 of FIG. 19. Hereinafter, an example of the federated search process executed by the federated search control program 1124 on the federated search server 1100 will be described.

### (FIG. 20: Step S701)

The federated search control program 1124 refers to the account correspondence management table 6100 managed by the federated search server 1100 to acquire the correspondence ID 6140 associated with the user who has requested the federated search.

### (FIG. 20: Step S702)

The federated search control program 1124 refers to the account correspondence management table 6100 managed by the federated search server 1100 to acquire the domain identifier 6110, the user ID 6120, the password 6130, and the like with the same correspondence ID as the correspondence ID 6140 acquired in step S701. The information acquired in the present step includes a plurality of records in some cases.

### (FIG. 20: Step S703)

The federated search control program 1124 refers to the search server management table 6200 managed by the federated search server 1100 to acquire the list of the registered search servers.

### (FIG. 20: Step S704)

The federated search control program 1124 determines whether a process described in steps S705 to S708 is applied to all search servers acquired in step S703. If the process is applied to all search servers, the process proceeds to step S709. If the process is not applied to all search servers, the process proceeds to step S705.

### (FIG. 20: Step S705)

The federated search control program 1124 selects arbitrary one of the search servers acquired in step S703 to which the process following the present step is not applied. The federated search control program 1124 refers to the search server management table 6200 managed by the federated search server 1100 to acquire the domain identifier 6250 registered in the record of the selected search server.

### (FIG. 20: Step S706)

The federated search control program 1124 examines whether the domain identifier 6250 acquired in step S705 is included in the domain identifier 6110 acquired in step S702. If the domain identifier 6250 is included, the process proceeds to step S707. If the domain identifier 6250 is not included, the process proceeds to step S708.

### (FIG. 20: Step S707)

For the search server 2200 selected in step S705, the federated search control program 1124 designates the representative user account 6230 acquired in step S703 and the representative user account password 6240 as the user authentication information for logging on to the search server 2200. The federated search control program 1124 also transmits, to the search server 2200, the search request designating the user ID 6120 acquired in step S702 as a filtering condition and acquires the result. After the present step, the process returns to step S704.

### (FIG. 20: Step S707: Supplement)

Only the access accounts necessary to access the shared folders to be searched by the search server 2200 are set to the access account information associated with the user who has requested the federated search. This can prevent transmission of the access account information, which is not necessary to trim the search result, to the search server.

### (FIG. 20: Step S708)

The federated search control program 1124 refers to the search server management table 6200 managed by the federated search server 1100 to examine whether the public account 6260 is registered in the search server selected in step S705. If the public account 6260 is registered, the process proceeds to step S707, and the public account is used to issue a search request to the search server. If the public account 6260 is not registered, the search request is not issued, and the process returns to step S704.

### (FIG. 20: Step S709)

The federated search control program 1124 federates the search results acquired from the search servers and returns the result to the request source to finish the process.

FIG. 21 is a diagram showing a flow of the search process in step S707 of FIG. 20. Hereinafter, an example of the search process executed by the search control program 2224 on the search server 2200 will be described. A flow of the search process when the search server 2200 has received the search request process from the search client control program 5124 on the client machine 5100 is similar.

### (FIG. 21: Step S801)

The search control program 2224 analyzes the content of the search request packet 8000 transmitted from the search request source and acquires the designated search conditions, the account information of the search request user, and the like.

### (FIG. 21: Step S802)

The search control program 2224 uses the index of the search server 2200 to extract a file group that meets the designated search conditions. At the point of the present step, the search control program 2224 uses search request user authentication information 8012 or session information 8016 in the search request packet 8000 to apply security trimming to the extracted files. Specifically, only the files, for which the access accounts stored in the user authentication information 8012 of the user who has requested the search have rights to refer to, and the files, for which the access accounts that can be specified using the session information 8016 have rights to refer to, are included in the search result.

### (FIG. 21: Step S803)

The search control program 2224 examines whether the user who has requested the search has a right to refer to all files extracted in step S802 and filters the search result to files for which the user has a right to refer to.

### (FIG. 21: Step S804)

After filtering the search result, the search control program 2224 returns the search result to the request source and ends the process.

### First Embodiment

### Summary

As described, the federated search server 1100 according to the first embodiment includes the account correspondence management table 6100 describing the correspondence between the access accounts that issue the federated search request and the access accounts that issue the search requests to the search servers. In accordance with the description of the account correspondence management table 6100, the federated search server 1100 specifies the access accounts on the search servers corresponding to the access accounts that issue the federated search request and sets the search conditions for returning, as a search result, only the range that can be accessed by the accounts to issue the search requests to the search servers. As a result, there is no need to transmit, to the search servers, the access account information unnecessary for the search servers to carry out the search, and the leak of the account information can be prevented to provide a secure federated search service.

In accordance with the description of the search server management table 6200, the federated search server 1100 according to the first embodiment specifies the search servers belonging to the same network domains as the network domains to which the access accounts that issue the federated search request belong and issues the search requests only to the search servers. As a result, there is no need to issue the search requests to the search servers that handle files for which the user who has requested the federated search does not have a right to refer to, and there is no need to execute a process of issuing unnecessary queries and waiting for responses. Therefore, the federated search process can be speeded up.

If there is no access account with a right to access the files searched by the search servers or if there is no search server belonging to the same domain as that of the access account, the federated search server 1100 according to the first embodiment can use the public accounts to issue the search requests to the search servers. As a result, a minimal search result can be obtained even if the user who has requested the federated search does not have an adequate access right.

### Second Embodiment

In the first embodiment, the representative user account 6230, the representative user account password 6240, and the like registered in the search server management table 6200 are used as the user authentication information 8012 in the search request packet 8000 when the search request is transmitted from the federated search server 1100 to the search server 2200 in step S707 of the federated search process described in FIG. 20. This is convenient that the user can surely log on to the search server 2200.

Meanwhile, when the search server 2200 has a function of acquiring an access log, the information of the access accounts that have accessed the search server 2200 is recorded in the access log. When the representative user account is used to log on to the search server 2200 as in the first embodiment, all representative user accounts are recorded in the access log at the time of the issue of the search request from the federated search server 1100 to the search server 2200.

Fundamentally, the representative user account is an account for accessing the files on the shared folders when the search server 2200 creates the index. Therefore, it is difficult for the search server 2200 to determine, just by referring to the access log, whether the access is an access for indexing by the search server 2200 or is an access based on the federated search from the user through the federated search server 1100. This is not desirable.

A second embodiment of the present invention describes an operation procedure of using, as the user authentication information 8012, access account information related to the user who has requested the federated search when the search request is issued from the federated search server 1100 to the search server 2200. The constituent elements constituting the federated search system 10000 are mostly the same as in the first embodiment. Therefore, differences will be mainly described.

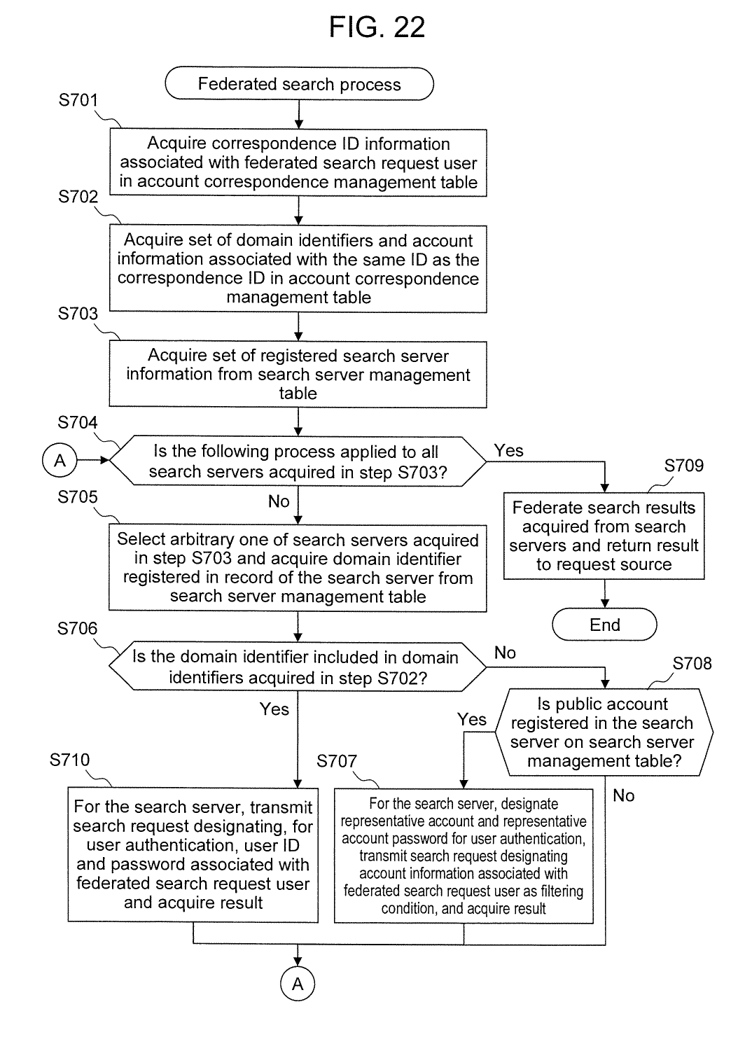

FIG. 22 is a diagram showing a flow of step S602 of FIG. 19 according to the second embodiment. Compared to the federated search process described in FIG. 20, the processing flow is different in that instead of the information of the representative user account, access account information associated with the user who has requested the federated search is stored in the field of the user authentication information 8012 in the search request packet 8000 when the search request is issued from the federated search server 1100 to the search server 2200. The difference from FIG. 20 will be mainly described.

### (FIG. 22: Step S706)

The federated search control program 1124 executes a process similar to step S706 of FIG. 20. However, if the domain identifier 6250 acquired in step S705 is included in the domain identifier 6110 acquired in step S702, the process proceeds to step S710 newly arranged in the second embodiment. The process proceeds to step S708 if the domain identifier 6250 is not included.

### (FIG. 22: Step S710)

The federated search control program 1124 transmits, to the search server 2200 selected in step S705, a search request designating the user ID 6120 and the password 6130 acquired in step S702 as the user authentication information for logging on to the search server and acquires the result. After the present step, the process returns to step S704.

### (FIG. 22: Step S710: Supplement 1)

The user ID 6120 used here is the access account information associated with the user who has requested the federated search. The search server 2200 that has received the search request executes the security trimming based on the access account information.

### (FIG. 22: Step S710: Supplement 2)

As in step S707, only the access accounts necessary for the search server 2200 to access the shared folders to be searched are set to the access account information associated with the user who has requested the federated search in the present step.

### Second Embodiment

### Summary

As described, the federated search server 1100 according to the second embodiment transmits, as the user authentication information, the access accounts associated with the user who has requested the federated search when the search request is issued to the search server 2200. As a result, the access accounts that have issued the search requests are recorded in the access log of the search server 2200, and this is desirable in terms of security management.

### Third Embodiment

In the first and second embodiments, the password 6130 of the access account is registered in the account correspondence management table 6100 in step S306 of FIG. 16. Meanwhile, the password information of the user may be periodically updated. If the password 6130 in the account correspondence management table 6100 is updated every time the password is updated, the management costs increase when the number of registered accounts is large.

A third embodiment of the present invention allows carrying out security trimming of the search result based on the access rights included in the access accounts, without registering the password information of the access accounts in the account correspondence management table 6100.

To enable carrying out the security trimming without the passwords of the access accounts, the representative user account needs to be used as the authentication information in the log-on to the search servers, and the user ID for identifying the access accounts needs to be designated as a filtering condition of the search result. Hereinafter, an example of operation for realizing this will be described. The constituent elements constituting the federated search system 10000 are mostly the same as in the first and second embodiments, and differences will be mainly described.

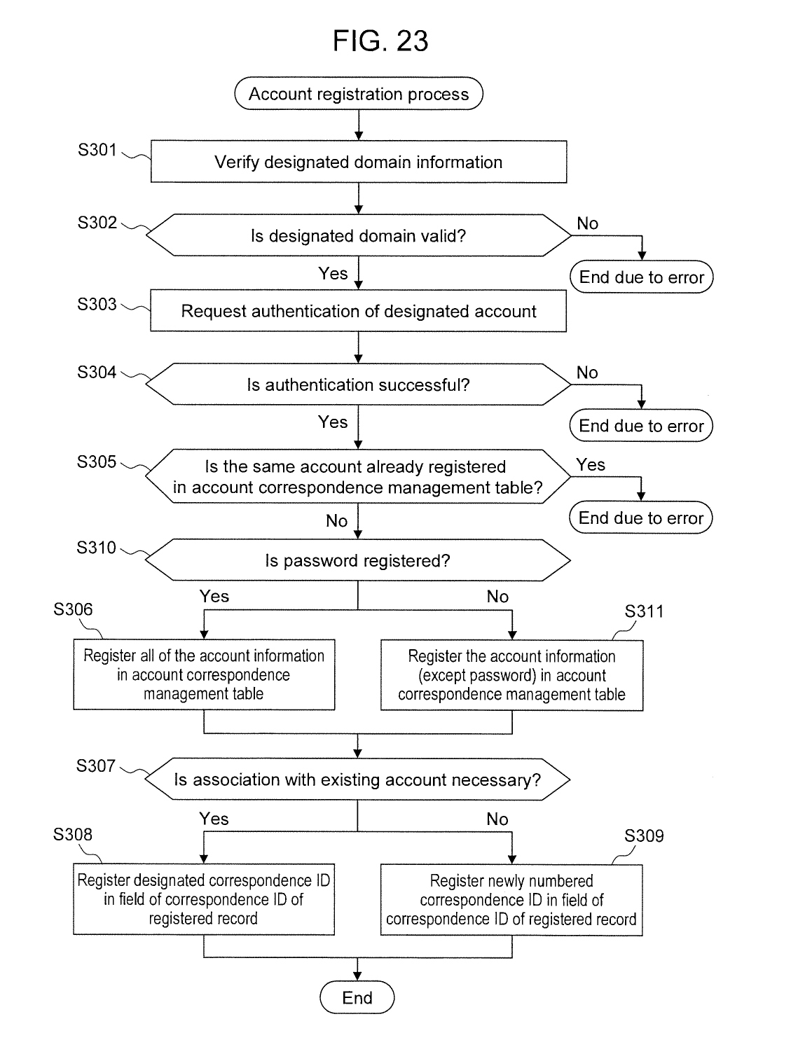

FIG. 23 is a diagram showing a flow of the access account registration process of steps S104 and S105 according to the third embodiment. In the processing flow, the difference from the account registration process described in FIG. 16 is that whether to register the password of the access account to be newly registered can be designated. The difference from FIG. 16 will be mainly described.

### (FIG. 23: Step S305)

The federated search server 1100 executes a process similar to step S305 of FIG. 16. However, if the access account designated to be registered is not registered, the process proceeds to newly arranged step S310.

### (FIG. 23: Step S310)

The federated search server 1100 determines whether to register the password information of the access account requested to be registered in the account correspondence management table 6100. If the password is to be registered, the process proceeds to step S306. If the password is not to be registered, the process proceeds to newly arranged step S311.

### (FIG. 23: Step S310: Supplement)

Password registration availability information is newly added to the account correspondence management table 6100 as a precondition for carrying out the present step. The federated search server 1100 refers to the password registration availability information to determine whether the password needs to be registered. In the access account registration process, the federated search server 1100 may provide a GUI interface or CLI interface for registration process, which can designate whether to register the password of the access account, to a person, such as the system administrator, who requests the process may determine whether the password needs to be registered based on the content of the designation in the interface.

### (FIG. 23: Step S311)

The federated search server 1100 registers the content of the access account information requested to be registered, except the password information, in the account correspondence management table 6100. When the password is not registered, information indicative of “not set” is registered in the field of the password 6130 of the account correspondence management table 6100. For example, a NULL value is registered here.

### (FIG. 23: Step S311: Supplement)

The user needs to log on to the federated search server 1100 as a precondition for the execution of the present process. Therefore, the user needs to notify the federated search server 1100 of the password, regardless of whether the password is registered in the account correspondence management table 6100.

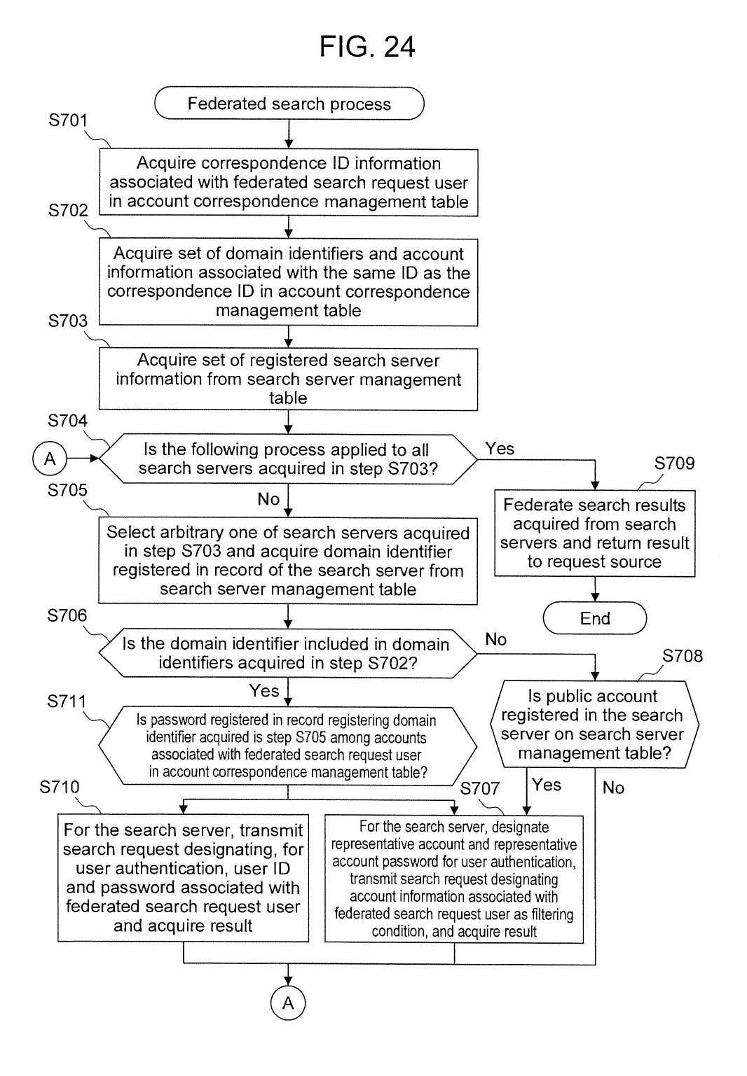

FIG. 24 is a diagram showing a flow of the federated search process of step S602 according to the third embodiment. In the processing flow, the difference from the federated search process described in FIG. 20 is that the access accounts used for the log-on authentication for the search servers are divided based on whether the password information is registered in the access accounts associated with the user who has requested the federated search. The difference from FIG. 20 will be mainly described.

### (FIG. 24: Step S706)

The federated search control program 1124 executes a process similar to step S706 of FIG. 20. However, if the domain identifier 6250 acquired in step S705 is included in the domain identifier 6110 acquired in step S702, the process proceeds to newly arranged step S711.

### (FIG. 24: Step S711)

The federated search control program 1124 refers to the account correspondence management table 6100 of the federated search server 1100 to select the access account information used to access the shared folders to be searched by the search servers, from the access account information associated with the user who has requested the federated search, and examines whether the password 6130 is registered in the record corresponding to the access account information in the account correspondence management table 6100. If the password is registered, the process proceeds to step S710. If the password is not registered, the process proceeds to step S707.

### (FIG. 24: Step S710)

The federated search control program 1124 uses the access account information associated with the user who has requested the federated search as the user authentication information for logging on to the search server and issues the search request.

### Third Embodiment

### Summary

As described, when the search request is issued to the search server 2200, the federated search server 1100 according to the third embodiment transmits, as the user authentication information, the access accounts associated with the user who has requested the federated search if the password 6130 is registered in the account correspondence management table 6100. The federated search server 1100 uses the representative user account as the user authentication information if the password 6130 is not registered. As a result, even if the password 6130 is not registered or updated on the federated search server 1100, the representative user account can be used to log on to the search servers, and the security trimming process can be executed. If the password 6130 is registered, the same advantageous effect as in the second embodiment can be attained.

### Fourth Embodiment

In the first to third embodiments, the representative user account 6230, the representative user account password 6240, and the like registered in the search server management table 6200 are stored in the user authentication information 8012 in the search request packet 8000 when the search request is transmitted from the federated search server 1100 to the search server 2200 in step S707.

Fundamentally, the representative user account is an account for accessing the files on the shared folders when the search server 2200 creates the index. If the representative user account is used to set the ACL to allow accessing the shared folders and the search servers, the representative user account may be used in step S707. However, there can be a case in which the use of the representative user account to access the search servers is not permitted.

The method of logging on to the search servers using the access account information associated with the user who has requested the federated search is described in step S710 of the second embodiment. In place of this, the common access account can be used as in the search result filtering account information 8022 described in the first embodiment. When the common account is used, the session established between the federated search server 1100 and the search server 2200 can be shared in the search requests from a plurality of users. Compared to the system establishing a separate session for each user as in the second embodiment, the method can reduce the amount of session management information that needs to be temporarily managed by the search servers.

In view of the foregoing, a common account that allows logging on to the search servers when the search request is issued to the search servers is newly arranged in a fourth embodiment of the present invention. The federated search server 1100 uses the common account to log on to the search servers when the search request is issued to the search servers.

The constituent elements constituting the federated search system 10000 are mostly the same as in the first to third embodiments except for the search server management table 6200. Therefore, differences will be mainly described.

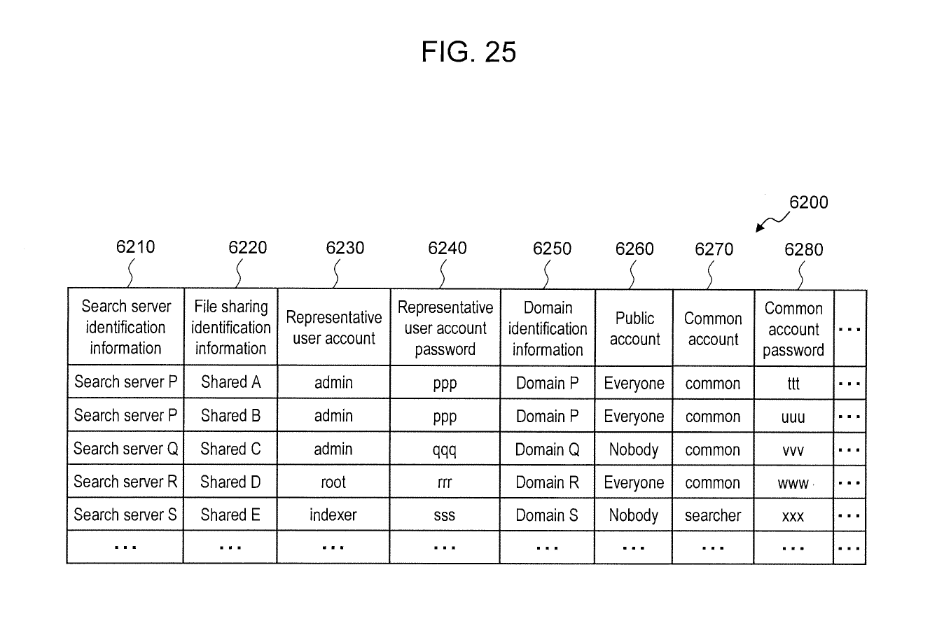

FIG. 25 is a diagram showing a configuration and an example of data of the search server management table 6200 according to the fourth embodiment. In the fourth embodiment, the search server management table 6200 newly includes a common account 6270 and a common account password 6280.

The common account 6270 is an access account necessary to access the search server 2200. When the target search server executes the authentication process, the common account 6270 and the common account password 6280 need to be registered in advance in the search server. When an authentication server different from the search server executes the authentication process, the common account 6270 and the common account password 6280 need to be registered in advance in the authentication server.

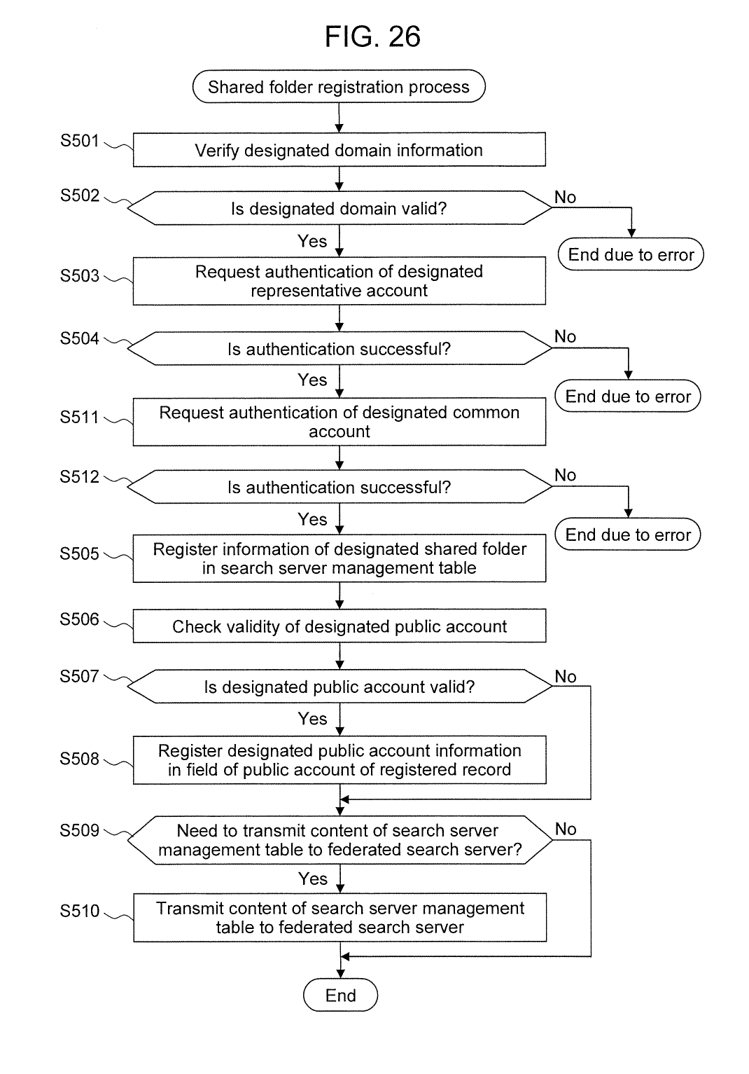

FIG. 26 is a diagram showing a flow of the process of step S402 according to the fourth embodiment. In the processing flow, the difference from the shared folder registration process described in FIG. 18 is that a process of registering common account information is added. The difference from FIG. 18 will be mainly described.

### (FIG. 26: Step S501)

As a precondition for the fourth embodiment, the system administrator designates the common account 6270 and the common account password 6280 when issuing a request for registering the shared folder. In the present step, the search server 2200 receives the information together.

### (FIG. 26: Step S504)

The search server 2200 executes a process similar to step S504 of FIG. 18. However, if the authentication is successful, the process proceeds to newly arranged step S511.

### (FIG. 26: Step S511)

The search server 2200 carries out the authentication of the designated common account. The search server executes the authentication process or requests an external authentication server used by the search server to execute the authentication process to acquire the result.

### (FIG. 26: Step S512)

After the execution of the authentication process of the common account, the search server 2200 examines whether the authentication process is successful. If the authentication has failed, the process is finished due to an error. If the authentication is successful, the process proceeds to step S505. The common account and the common account password are registered together in step S505.

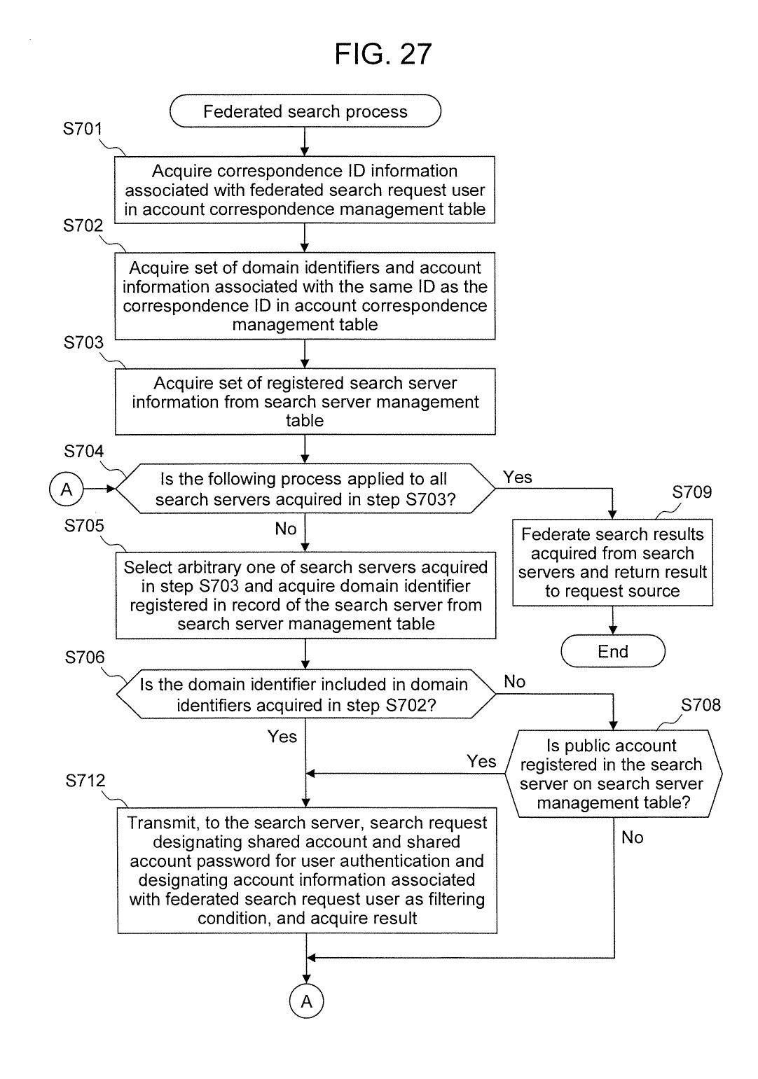

FIG. 27 is a diagram showing a flow of the federated search process of step S602 according to the fourth embodiment. In the processing flow, the difference from the federated search process described in FIG. 20 is that instead of the information of the representative user accounts, the information of the common account is stored in the field of the user authentication information 8012 in the search request packet 8000 when the search request is issued from the federated search server 1100 to the search server 2200. The difference from FIG. 20 will be mainly described.

### (FIG. 27: Step S706)

The federated search control program 1124 executes a process similar to step S706 of FIG. 20. However, if the domain identifier 6250 acquired in step S705 is included in the domain identifier 6110 acquired in step S702, the process proceeds to step S712 newly arranged in the fourth embodiment.

### (FIG. 27: Step S712)

The federated search control program 1124 transmits, to the search server 2200 selected in processing step S705, a search request designating the common account and the common account password as the user authentication information and designating the user ID 6120 acquired in step S702 as the filtering condition and acquires the result. After the present step, the process returns to step S704.

### (FIG. 27: Step S712: Supplement 1)

The common account and the common account password used in the present step is the common account 6270 and the common account password 6280 of the records registering the information of the search servers as counterparts of issuing the search request of the present step in the search server management table 6200.

### (FIG. 27: Step S712: Supplement 2)

As in the first embodiment, only the access accounts necessary to access the shared folders to be searched by the search server 2200 are transmitted to the access account information associated with the user who has requested the federated search.

### Fourth Embodiment

### Summary

As described, the federated search server 1100 according to the fourth embodiment uses the common account, in place of the representative user account, to carry out the log-on when the search request is issued to the search servers. As a result, the search request can be carried out without using the representative user account that is fundamentally used to create the search index. Therefore, when all files cannot be accessed only by the access right for creating the search index or when the right of the access right is too strong, the common account with a more appropriate access right can replace the access right.

### Fifth Embodiment

In the first to fourth embodiments, the search server 2200 carries out the security trimming in step S803, in which the search result is formed by filtering the files included in the search result to files for which the user who has requested the federated search has a right to refer to. The federated search server 1100 that requests the search may carry out the security trimming.

The federated search server 1100 needs to acquire information related to all files that meet the search conditions in order to enable the federated search server 1100 to carry out the security trimming. The federated search server 1100 can cache the information, and the cache can be used to skip the search request to the search servers when there is a federated search request from another user based on the same search conditions.

A fifth embodiment of the present invention describes an example of operation of designating whether the search server carries out the security trimming when the search request is issued from the federated search server 1100 to the search servers.

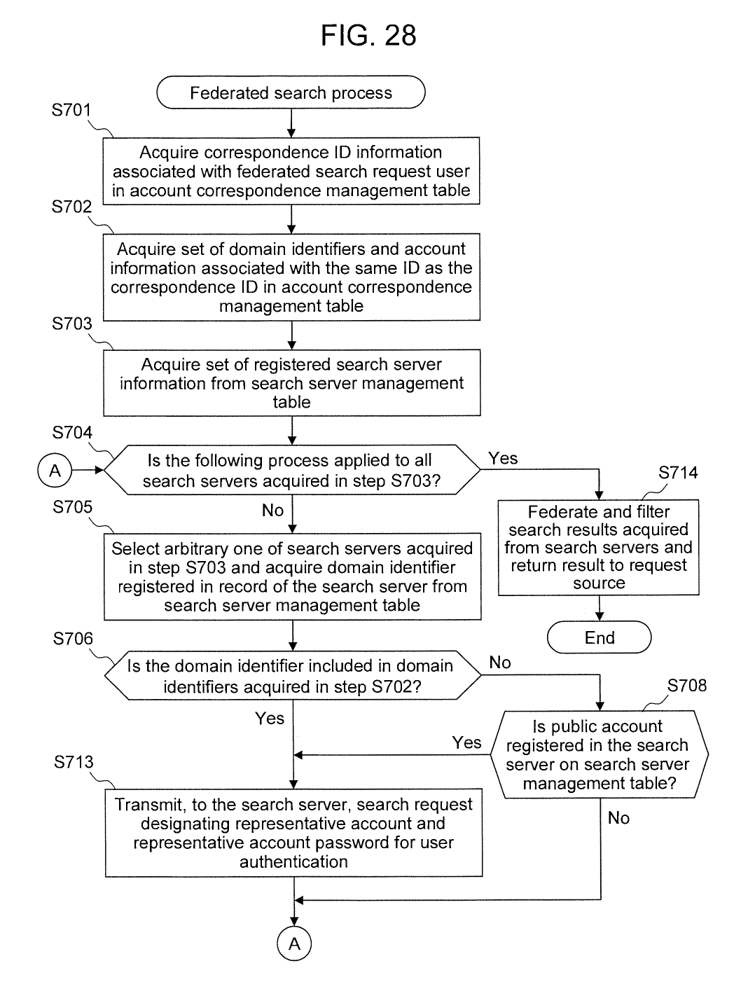

FIG. 28 is a diagram showing a flow of the federated search process of step S602 according to the fifth embodiment. In the processing flow, the difference from the federated search process described in FIG. 20 is that the search conditions are not designated in the field of the search result filtering account information 8022 in the search request packet 8000 when the search request is issued from the federated search server 1100 to the search server 2200. The difference from FIG. 20 will be mainly described.

### (FIG. 28: Step S704)

The federated search control program 1124 executes a process similar to step S704 of FIG. 20. However, if the process of steps S705 to S708 is executed for all search servers, the process proceeds to step S714 newly arranged in the fifth embodiment.

### (FIG. 28: Step S706)

The federated search control program 1124 executes a process similar to step S706 of FIG. 20. However, if the domain identifier 6250 acquired in step S705 is included in the domain identifier 6110 acquired in step S702, the process proceeds to step S713 newly arranged in the fifth embodiment.

### (FIG. 28: Step S713)

The federated search control program 1124 transmits, to the search server 2200 selected in step S705, a search request designating the representative user account and the representative user account password as the user authentication information and not designating any filtering condition and acquires the result. As for the filtering conditions, the search condition is not set in the field of the search result filtering account information 8022 in the search request packet 8000. After the present step, the process returns to step S704.

### (FIG. 28: Step S714)

The federated search control program 1124 federates the search results acquired from the search servers and uses the access account information associated with the user who has requested the federated search to carry out the security trimming of the search results.

### (FIG. 28: Step S714: Supplement)

The search results before the security trimming may be cached inside the federated search server 1100 if necessary. As for the cached content, the cached data can be used as all or part of the federated search result if the search conditions are met and if a predetermined period has not passed for the cached content when the next or subsequent federated search request is received.

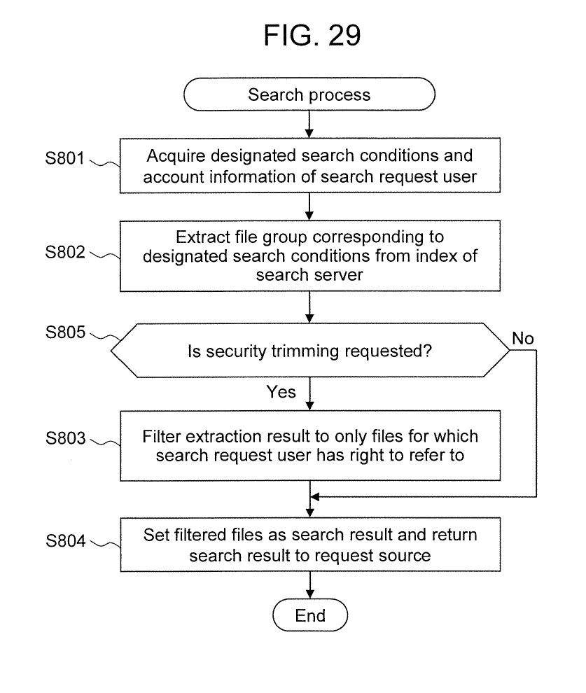

FIG. 29 is a diagram showing a flow of the search process of step S707 in the fifth embodiment. In the processing flow, the difference from the search process described in FIG. 21 is that whether to carry out the security trimming is determined based on the content of the search request packet 8000 transmitted from the federated search server 1100. The difference from FIG. 21 will be mainly described.

### (FIG. 29: Step S802)

The search control program 2224 executes a process similar to step S802 of FIG. 21. However, after the present step, step S805 newly arranged in the fifth embodiment is executed before step S803.

### (FIG. 29: Step S805)

The search control program 2224 examines whether the execution of the security trimming is requested. Specifically, the search control program 2224 examines whether the access account information for filtering is stored in the search result filtering account information 8022 in the search request packet 8000 transmitted from the federated search server 1100. If the access account information is not stored in the search result filtering account information 8022, it is determined that the security trimming is not requested. If it is determined that the security trimming is requested, the process proceeds to step S803. If it is determined that the security trimming is not requested, the process skips to step S804.

### Fifth Embodiment

### Summary

As described, the federated search server 1100 according to the fifth embodiment can designate whether the search server carries out the security trimming when the search request is issued to the search server 2200. As a result, a flexible process can be executed, such as by adjusting which of the servers will carry out the security trimming in accordance with the processing load of the search servers.

### Sixth Embodiment

In the first to fifth embodiments, different server apparatuses provide the federated search server 1100 and the search server 2200. However, one server apparatus may have both functions of the federated search server 1100 and the search server 2200. A sixth embodiment of the present invention describes an example of a configuration in which the search server 2200 also provides the function of the federated search server 1100.

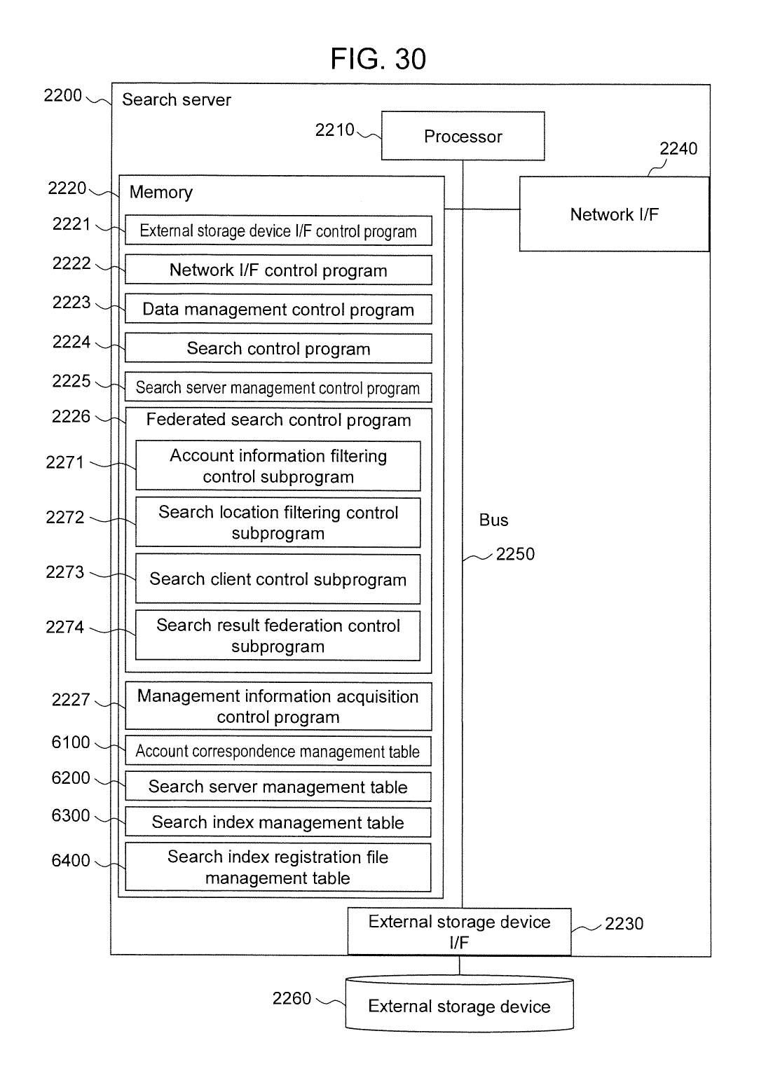

FIG. 30 is a diagram showing a hardware configuration of the search server 2200 according to the sixth embodiment. In FIG. 30, a federated search control program 2226 and a management information acquisition control program 2227 are newly added to the configuration described in FIG. 3.

The federated search control program 2226 is the same as the federated search control program 1124 in the federated search server 1100 described in FIG. 2. An account information filtering control subprogram 2271, a search location filtering control subprogram 2272, a search client control subprogram 2273, and a search result federation control subprogram 2274 as the constituent elements of the federated search control program 2226 are also the same. The management information acquisition control program 2227 is the same as the management information acquisition control program 1125 in the federated search server 1100 described in FIG. 2.

Processing flows provided by the added control programs are the same as the processing flows described as the content of the processes in the federated search server 1100. Therefore, the description of the processing flows will not be repeated.

Although one server apparatus provides the federated search server 1100 and the search server 2200 in the description above, the arrangement is not limited to this. For example, the function of the authentication server 3200 may also be integrally provided, and the function of the file server 4200 may also be integrally provided. These four servers may also be flexibly combined. A server virtualization technique may be used to form a plurality of virtual server apparatuses in one physical server apparatus, and the virtual server apparatuses may provide the federated search server 1100, the search server 2200, the authentication server 3200, and the file server 4200. The virtual server apparatuses may also provide the search server 2200 including the function of the federated search server 1100.

### Sixth Embodiment

### Summary

As described, according to the sixth embodiment, the number of server apparatuses constituting the system that provides the federated search service can be reduced. One server apparatus can realize the federated search server 1100 and the search server 2200 to reduce the overhead in the network transfer. When the same data is handled, the data storage memory area can be shared to reduce the memory consumption.

### Seventh Embodiment

In the first to sixth embodiments, the federated search server 1100 that has received the federated search request serves as a base point to issue the search request to the search servers in the federated search process described in FIG. 7, and the search servers that have received the search requests return the search results based on the index information of the search servers. Meanwhile, the search servers that have received the search requests may serve as base points to execute a multi-stage federated search process for performing the federated search.

According to the configuration, the federated search can be efficiently carried out. Particularly, compared to the single-stage federated search, the multi-stage configuration can disperse the load of the federated search server 1100 as the base point to the search servers if there are a large number of search servers.

A seventh embodiment of the present invention describes an example of a configuration for realizing the multi-stage federated search. The description here is based on a configuration in which the federated search server 1100 and the search server 2200 are federated, as described in the sixth embodiment. However, the multi-stage federated search described below can be realized even if the federated search server 1100 and the search server 2200 are provided as separate server apparatuses as in the first embodiment.

To realize the multi-stage federated search, a change needs to be made to be able to designate whether there is a need to carry out the federated search after issuing the search request from the federated search control program 2226 to the search servers, and then a change needs to be made to be able to determine whether the search server that has received the search request needs to serve as the base point to carry out the federated search.

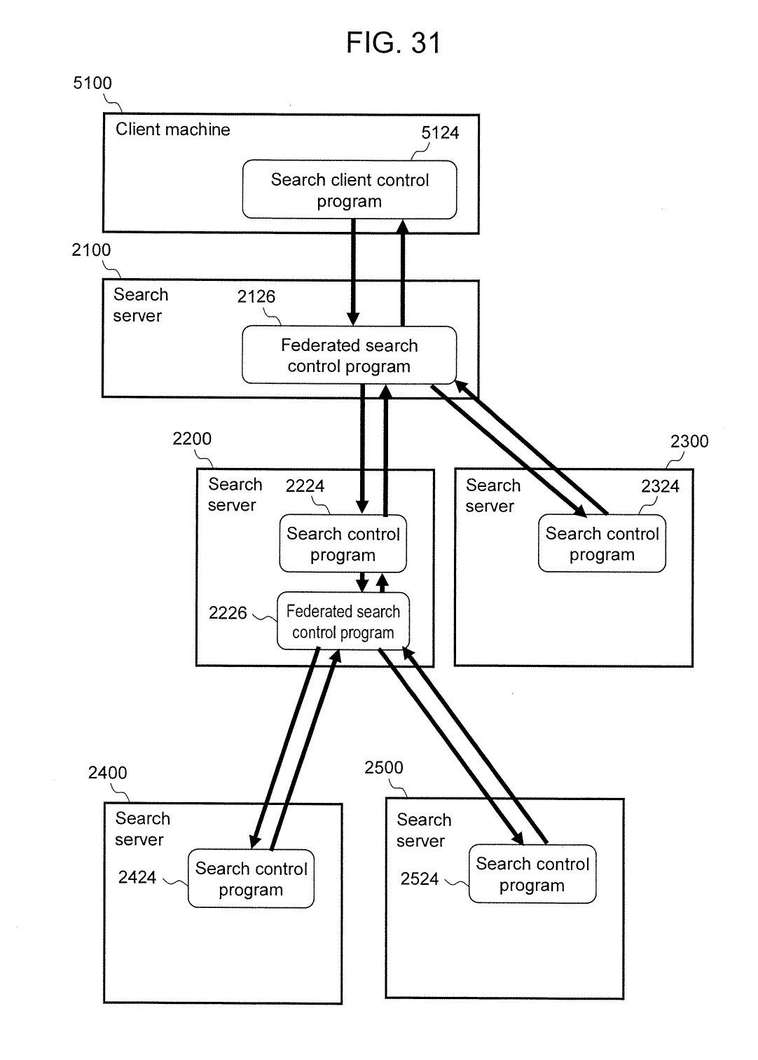

FIG. 31 is a diagram showing a flow of the entire federated search process according to the seventh embodiment. FIG. 31 is equivalent to the process of FIG. 7 in the seventh embodiment. Compared to the flow of the entire process described in FIG. 7, FIG. 31 is different in that the federated search is carried out in multiple stages.

The federated search control program 2126 that has received the federated search request from the search client control program 5124 further transmits, to the federated search servers 2200 and 2300 as the search targets, control information indicating whether the federated search needs to be performed, along with the search request. The control information will be described later.

In the search servers 2200 and 2300, the search control programs 2224 and 2324 receive the search request, and in addition to the search process described in FIG. 7, determine whether to carry out the federated search with the servers serving as the base points, based on the content of the control information.

If the search control program 2224 determines to carry out the federated search with the server serving as the base point, the search control program 2224 requests the federated search control program 2226 of the server to carry out the federated search.

The federated search control program 2226 that has received the federated search request further issues the search request to the search servers 2400 and 2500, acquires the results, and returns the results to the request source.

The process is repeated, and the search server that has first received the federated search request lastly organizes the search results and returns the federated search result to the request source.

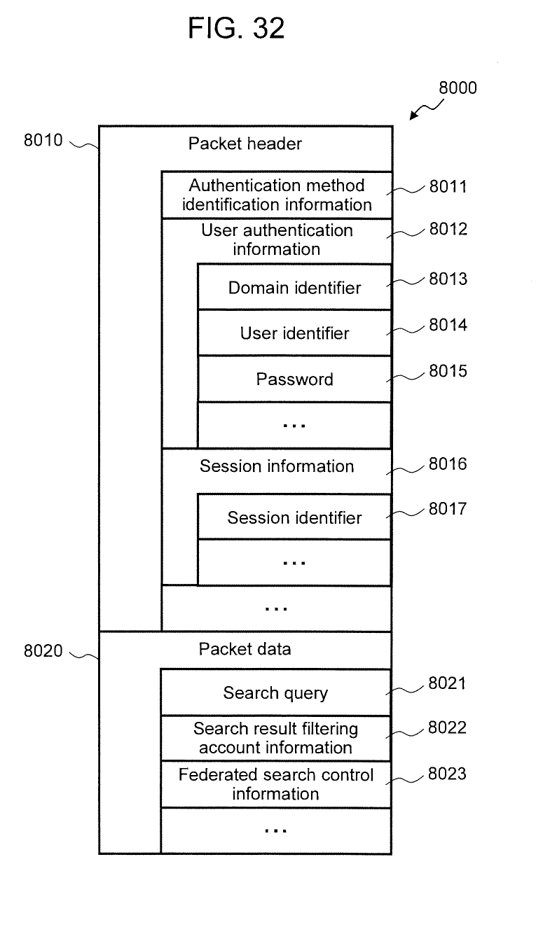

FIG. 32 is a diagram showing a data structure of the search request packet 8000 according to the seventh embodiment. In the seventh embodiment, the difference from FIG. 9 is that federated search control information 8023 is added to the search request packet 8000.

The federated search control information 8023 stores information indicating whether the federated search needs to be further carried out in the search server that has received the search request. Specifically, the federated search control information 8023 stores information indicating whether the federated search needs to be carried out or does not need to be carried out.

When the information indicating that the federated search needs to be carried out is stored in the federated search control information 8023, the conditions for carrying out the federated search may be designated. For example, the limit number of times of carrying out the federated search in multiple stages with the search server as the base point may be designated. Conditions for selecting the search server that newly issues the search request with the search server as the base point may also be designated. The use of the selection conditions of the search server can prevent issuing redundant search requests to the same search server.

To prevent the redundant search requests, the search server that has first received the federated search can designate the selection conditions to prevent the search requests from overlapping in the implementation of the multi-stage federated search based on the configuration information of the search server group. Specifically, when a graph of the transmission relationship of the search requests between the search servers is formed in a tree structure, generation of a node that has a plurality of parent nodes as transmission sources of the search requests can be prevented.

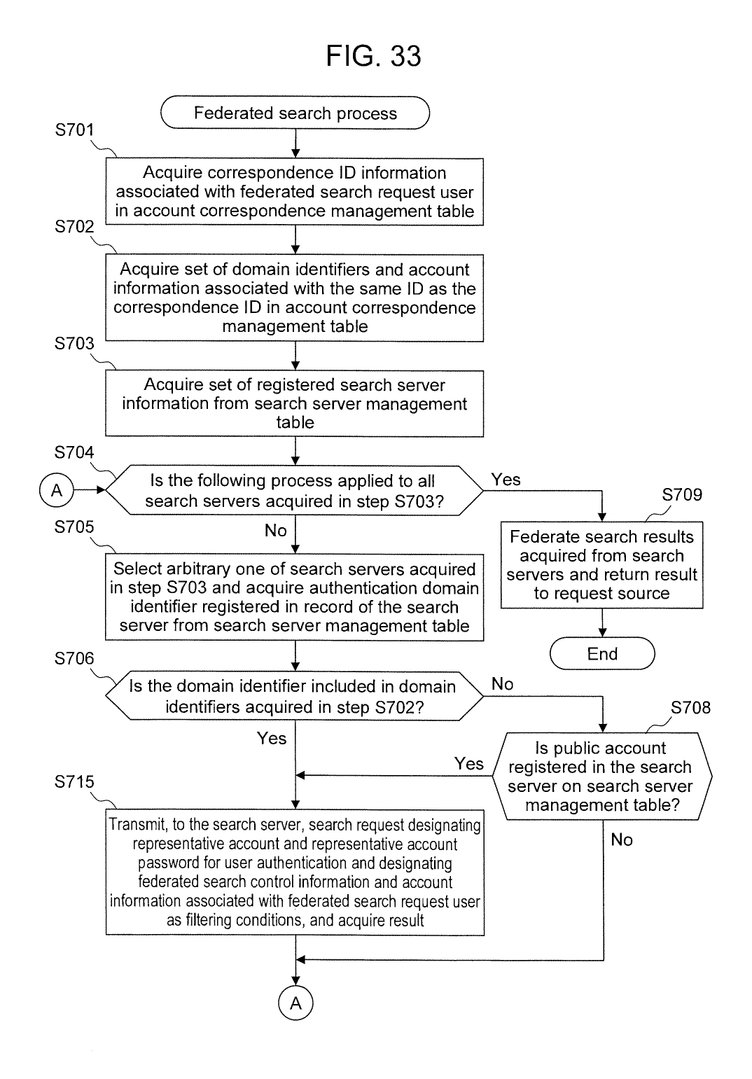

FIG. 33 is a diagram showing a flow of the federated search process of step S602 according to the seventh embodiment. In the processing flow, the difference from the federated search process described in FIG. 20 is that information for controlling the multi-stage federated search is stored in the field of the federated search control information 8023 in the search request packet 8000 when the search request is issued from the federated search server 1100 to the search server 2200. The difference from FIG. 20 will be mainly described.

### (FIG. 33: Step S706)

The federated search control program 1124 executes a process similar to step S706 of FIG. 20. However, if the domain identifier 6250 acquired in step S705 is included in the domain identifier 6110 acquired in step S702, the process proceeds to step S715 newly arranged in the seventh embodiment.

### (FIG. 33: Step S715)

The federated search control program 1124 transmits, to the search server 2200 selected in step S705, a search request designating the representative user account and the representative user account password as the user authentication information, designating the user 6120 acquired in step S702 as a filtering condition, and designating the federated search control information 8023 for controlling the multi-stage federated search. The federated search control program 1124 acquires the result. After the present step, the process returns to step S704.

### (FIG. 33: Step S715: Supplement 1)

The content described in FIG. 32 can be set for the federated search control information 8023 designated in the present step.

### (FIG. 33: Step S715: Supplement 2)

As in the first embodiment, only the access accounts necessary to access the shared folders as the search targets of the search server 2200 are transmitted to the access account information associated with the user who has requested the federated search.

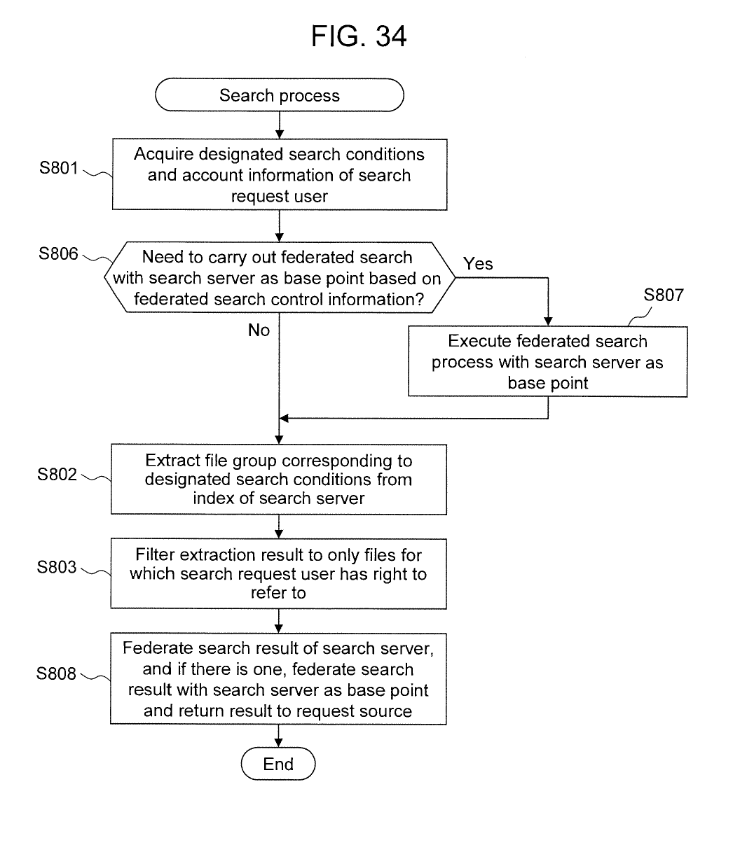

FIG. 34 is a diagram showing a flow of the search process of step S707 according to the seventh embodiment. In the processing flow, the difference from the search process described in FIG. 21 is that whether to carry out the federated search is further determined based on the content of the search request packet 8000 transmitted from the federated search server 1100. The difference from FIG. 21 will be mainly described.

### (FIG. 34: Step S801)

The search control program 2224 executes a process similar to step S801 of FIG. 21. However, after the present step, step S806 newly arranged in the seventh embodiment is executed before step S802.

### (FIG. 34: Step S806)

The search control program 2224 examines whether the federated search process with the server as the base point is requested. Specifically, the search control program 2224 examines the federated search control information 8023 in the search request packet 8000 transmitted from the federated search server 1100. The search control program 2224 determines that further federated search is necessary if information indicating that the federated search is necessary is stored and determines that the federated search is not necessary if information indicating that the federated search is not necessary is stored. The process proceeds to step S807 if the search control program 2224 determines that further federated search is necessary. The process proceeds to step S802 if the search control program 2224 determines that the federated search is not necessary.

### (FIG. 34: Step S807)

The search control program 2224 executes the federated search process with the search server as the base point. Specifically, the search control program 2224 requests the federated search control program 2226 in the search server to execute the federated search process. After the present step, the process proceeds to step S802.

### (FIG. 34: Step S803)

The search control program 2224 executes a process similar to step S803 of FIG. 21. However, after the present step, the search control program 2224 executes step S808 newly arranged in the seventh embodiment.

### (FIG. 34: Step S808)

The search control program 2224 federates the search result in the search server (search result acquired in step S803) and the federated search result with the search server as the base point if there is one (search result acquired in step S807) and returns the result to the request source.

### Seventh Embodiment

### Summary

As described, according to the seventh embodiment, the federated search is carried out in multiple stages, and the federated search system 10000 can be more flexibly constructed.

The present invention can be realized by various forms such as a computer program that realizes the server apparatuses, a recording medium that records the program, and a data signal including the program and embodied in a carrier. All or part of the configurations, the functions, the processing units, and the like can be realized as hardware by designing the configurations, the functions, the processing units, and the like by federated circuits.

When the present invention is constituted by a computer program, a recording medium that records the program, or the like, the present invention may be constituted by a server apparatus or by the entire program that controls the server apparatus, or only the part that attains the functions of the present invention may be constituted by a program or a recording medium.

Examples of the recording medium that can be used include a flexible disk, a CD-ROM, a DVD-ROM, a punch card, and a printed matter with printed signs such as a bar code, as well as various computer-readable volatile storage media and non-volatile storage media, such as an internal storage device and an external storage device of a computer.

### DESCRIPTION OF SYMBOLS

100 . . . network
1100 . . . federated search server
2200, 2300 . . . search servers
3100, 3200, 3300 . . . authentication servers
4200, 4300 . . . file servers
5100 . . . client machine
1110, 2210, 3110, 4210, 5110 . . . processors
1120, 2220, 3120, 4220, 5120 . . . memories
1121, 2221, 3121, 4221, 5121 . . . external storage device I/F control programs
1122, 2222, 3122, 4222, 5122 . . . network I/F control programs
1123, 2223, 3123, 4223, 5123 . . . data management control programs
1124, 2226 . . . federated search control programs
1125, 2227 . . . management information acquisition control programs
1171, 2271 . . . account information filtering control subprograms
1172, 2272 . . . search location filtering control subprograms
1173, 2273 . . . search client control subprograms
1174, 2274 . . . search result federation control subprograms
2224 . . . search control program
2225 . . . search server management control program
3124 . . . authentication control program
4224 . . . file sharing control program
5124 . . . search client control program
5125 . . . file sharing client control program
1130, 2230, 3130, 4230, 5130 . . . external storage device I/Fs
1140, 2240, 3140, 4240, 5140 . . . network I/Fs
1150, 2250, 3150, 4250, 5150 . . . buses
1160, 2260, 3160, 4260, 5160 . . . external storage devices
6100 . . . account correspondence management table
6110 . . . domain identification information
6120 . . . user ID
6130 . . . password
6140 . . . correspondence ID
6200 . . . search server management table
6210 . . . search server identification information
6220 . . . file sharing identification information
6230 . . . representative user account
6240 . . . representative user account password
6250 . . . domain identification information
6260 . . . public account
6270 . . . common account
6280 . . . common account password
6300 . . . search index management table
6310 . . . keyword
6320 . . . corresponding location information
6321, 6324 . . . file identification information
6322, 6325 . . . corresponding location offsets
6323, 6326 . . . weights
6400 . . . search index registration file management table
6410 . . . file identification information
6420 . . . file path name
6430 . . . ACL information
6431 . . . user/group identification information
6432 . . . operation content
6433 . . . approval/disapproval designation flag
6440 . . . metadata
7000 . . . federated search request packet
7010 . . . packet header
7011 . . . authentication method identification information
7012 . . . user authentication information
7013 . . . domain identifier
7014 . . . user identifier
7015 . . . password
7016 . . . session information
7017 . . . session identifier
7020 . . . packet data
7021 . . . search query
8000 . . . search request packet
8010 . . . packet header
8011 . . . authentication method identification information
8012 . . . user authentication information
8013 . . . domain identifier
8014 . . . user identifier
8015 . . . password
8016 . . . session information
8017 . . . session identifier
8020 . . . packet data
8021 . . . search query
8022 . . . search result filtering account information
8023 . . . federated search control information

What is claimed is:

1. A federated search apparatus comprising:
a search client control unit that receives a first search request for searching for electronic data;
a federated search control unit that issues a second search request to one or more search apparatuses that search for electronic data based on the first search request and that federates search results of the search apparatuses;
an account filtering control unit that filters access accounts when the federated search control unit issues the second search request to the search apparatuses; and
an account correspondence table describing a correspondence between a first access account that issues the first search request and second access accounts used by a user who has the first access account to access the search apparatuses, wherein
the account filtering control unit
specifies the second access account corresponding to the first access account in accordance with the description of the account correspondence table when the federated search control unit issues the second search request to the search apparatuses, and
the federated search control unit
designates, as a search condition, a range of the electronic data that can be accessed by the second access account specified by the account filtering control unit in accordance with the description of the account correspondence table and issues the second search request.

2. The federated search apparatus according to claim 1, further comprising
a search apparatus management table describing network domains to which the search apparatuses belong, wherein
the account correspondence table
describes a correspondence between network domains to which the second access accounts belong and the first access account,
the account filtering control unit
specifies the search apparatus belonging to the network domain to which the second access account belongs in accordance with the description of the search apparatus management table, and
the federated search control unit
issues the second search request to the search apparatus specified by the account filtering control unit in accordance with the description of the search apparatus management table.

3. The federated search apparatus according to claim 1, wherein
if there is no second access account specified by the account filtering control unit in accordance with the description of the account correspondence table,
the federated search control unit
designates, as a search condition, a range of the electronic data that can be accessed by a public access account that does not require authentication and issues the second search request.

4. The federated search apparatus according to claim 2, wherein
if there is no search apparatus specified by the account filtering control unit in accordance with the description of the search apparatus management table,
the federated search control unit
designates, as a search condition, a range of the electronic data that can be accessed by a public access account that does not require authentication and issues the second search request.

5. The federated search apparatus according to claim 2, wherein
the search apparatus management table
describes a representative access account with an access right to all the electronic data accessed by the search apparatuses and authentication information of the representative access account, and
the federated search control unit
acquires the authentication information of the representative access account in accordance with the description of the search apparatus management table when issuing the second search request to the search apparatuses and
uses the authentication information of the representative access account as log-in authentication information for the search apparatuses to issue the second search request.

6. The federated search apparatus according to claim 1, wherein
the federated search control unit
uses authentication information of the second access accounts as the log-in authentication information for the search apparatuses to issue the second search request and
receives, from the search apparatuses, search results obtained by the search apparatuses extracting only the search results related to the electronic data for which the second access accounts have an access right.

7. The federated search apparatus according to claim 5, wherein
if the account correspondence table describes the authentication information of the second access accounts,
the federated search control unit
uses the authentication information of the second access accounts as the log-in authentication information for the search apparatuses to issue the second search request and
receives, from the search apparatuses, search results obtained by the search apparatuses extracting only the search results related to the electronic data for which the second access accounts have an access right and
if the account correspondence table does not describe the authentication information of the second access accounts,
the federated search control unit
acquires the authentication information of the representative access account in accordance with the description of the search apparatus management table when issuing the second search request to the search apparatuses and
uses the authentication information of the representative access account as the log-in authentication information for the search apparatuses to issue the second search request.

8. The federated search apparatus according to claim 2, wherein
the search apparatus management table
describes a common access account with a right to issue a search request to all the electronic data that can be searched by the search apparatuses to acquire search results of the search request and describes authentication information of the common access account, and
the federated search control unit
acquires the authentication information of the common access account in accordance with the description of the search apparatus management table when issuing the second search request to the search apparatuses and
uses the authentication information of the common access account as the log-in authentication information for the search apparatuses to issue the second search request.

9. The federated search apparatus according to claim 1, wherein
the federated search control unit
instructs the search apparatuses whether to execute an extraction process of extracting only the search results related to the electronic data for which the second access accounts have an access right, when issuing the second search request to the search apparatuses, and
federates the search results of the search apparatuses when instructing the search apparatuses not to execute the extraction process.

10. The federated search apparatus according to claim 1, wherein
the federated search control unit
receives results of the federation from one or more other federated search apparatuses that integrate the results of the search for the electronic data by the search apparatuses and
further federates the results of the federation from the federated search apparatuses.

11. The federated search apparatus according to claim 1, further comprising
a search apparatus management table describing network domains to which the search apparatuses belong, wherein
the search apparatus management table
describes a representative access account with an access right to all the electronic data accessed by the search apparatuses and authentication information of the representative access account,
the account correspondence table
describes a correspondence between network domains to which the second access accounts belong and the first access account,
the account filtering control unit
specifies the search apparatus belonging to the network domain to which the second access account belongs in accordance with the description of the search apparatus management table, and
the federated search control unit
issues the second search request to the search apparatus specified by the account filtering control unit in accordance with the description of the search apparatus management table
designates, as a search condition, a range of the electronic data that can be accessed by a public access account that does not require authentication and issues the second search request if there is no second access account specified by the account filtering control unit in accordance with the description of the account correspondence table,
if there is no search apparatus specified by the account filtering control unit in accordance with the description of the search apparatus management table, designates, as a search condition, a range of the electronic data that can be accessed by a public access account that does not require authentication and issues the second search request,
if the account correspondence table describes the authentication information of the second access accounts, uses the authentication information of the second access accounts as the log-in authentication information for the search apparatuses to issue the second search request and receives, from the search apparatuses, search results obtained by the search apparatuses extracting only the search results related to the electronic data for which the second access accounts have an access right,
if the account correspondence table does not describe the authentication information of the second access accounts, acquires the authentication information of the representative access account in accordance with the description of the search apparatus management table when issuing the second search request to the search apparatuses and uses the authentication information of the representative access account as the log-in authentication information for the search apparatuses to issue the second search request,
instructs the search apparatuses whether to execute an extraction process of extracting only the search results related to the electronic data for which the second access accounts have an access right, when issuing the second search request to the search apparatuses, federates the search results of the search apparatuses when instructing the search apparatuses not to execute the extraction process,
receives results of the federation from one or more other federated search apparatuses that integrate the results of the search for the electronic data by the search apparatuses, and further federates the results of the federation from the federated search apparatuses.

12. A federated search system comprising:
the federated search apparatus according to claim 1;
one or more search apparatuses that search for electronic data; and
one or more authentication apparatuses that authenticate access to the search apparatuses, wherein
the authentication apparatuses
authenticate whether the second access accounts have a right to issue search requests to the search apparatuses and acquire search results.

13. A federated search system comprising:
the federated search apparatus according to claim 2;
two or more search apparatuses that search for electronic data; and
one or more authentication apparatuses that authenticate access to the search apparatuses, wherein
at least one or more search apparatuses
belong to different network domains from the other search apparatuses, and
the authentication apparatuses
authenticate whether the second access accounts have a right to issue search requests to the search apparatuses to the search apparatus and acquire search results, under network domains to which the search apparatuses belong.

14. A federated search system comprising:
the federated search apparatus according to claim 5;
one or more search apparatuses that search for electronic data; and
a file server that stores the electronic data, wherein
the search apparatuses
use the access right of the representative access account to access the electronic data stored in the file server and create a search index for the search.

15. A federated search system comprising:
the federated search apparatus according to claim 6; and
one or more search apparatuses that search for electronic data, wherein
the search apparatuses
extract only search results related to the electronic data, for which the second access accounts have an access right, among the search results, when the second search request is received, and return the search results to the federated search apparatus.

16. A federated search system comprising:
the federated search apparatus according to claim 9; and
one or more search apparatuses that search for electronic data, wherein
the search apparatuses
receive, from the federated search apparatus, an instruction of whether to execute an extraction process of extracting only search results related to the electronic data for which the second access accounts have an access right,
extract only the search results related to the electronic data, for which the second access accounts have an access right, among the search results, if an instruction for executing the extraction process is received, and return the search results to the federated search apparatus.

17. A federated search method comprising:
a step of receiving a first search request for searching for electronic data;
a step of reading an account correspondence table describing a correspondence between a first access account that issues the first search request and second access accounts used by a user who has the first access account to access the search apparatuses;
a federated search control step of issuing a second search request to one or more search apparatuses that search for electronic data based on the first search request and integrating search results of the search apparatuses; and
an account filtering control step of filtering access accounts when the second search request is issued to the search apparatuses, wherein
the account filtering control unit comprises
a step of specifying the second access account corresponding to the first access account in accordance with the description of the account correspondence table when the second search request is issued to the search apparatuses in the federated search control step, and
in the federated search control step,
a range of the electronic data that can be accessed by the second access account specified in the account filtering control step in accordance with the description of the account correspondence table is designated as a search condition, and the second search request is issued.

18. The federated search method according to claim 17, further comprising
a step of reading a search apparatus management table describing network domains to which the search apparatuses belong, wherein
the account correspondence table
describes a correspondence between network domains to which the second access accounts belong and the first access account,
in the account filtering control step
the search apparatuses belonging to the network domains to which the second access accounts belong are specified in accordance with the description of the search apparatus management table, and
in the federated search control step
the second search request is issued to the search apparatuses specified in the account filtering control step in accordance with the description of the search apparatus management table.

19. The federated search method according to claim 17, wherein
in the federated search control step,
if there is no second access account specified in the account filtering control step in accordance with the description of the account correspondence table,
a range of the electronic data that can be accessed by a public access account that does not require authentication is designated as a search condition, and the second search request is issued.

20. The federated search method according to claim 18, wherein
in the federated search control step,
if there is no search apparatus specified in the account filtering control step in accordance with the description of the search apparatus management table,
a range of the electronic data that can be accessed by a public access account that does not require authentication is designated as a search condition, and the second search request is issued.
